(19) United States
(12) Patent Application Publication
(10) Pub. No.: US 2025/0246030 A1
(43) Pub. Date: Jul. 31, 2025

(54) DRIVING ASSISTANCE SYSTEM AND DRIVING ASSISTANCE METHOD

(71) Applicant: Panasonic Automotive Systems Co., Ltd., Kanagawa (JP)

(72) Inventors: Taiki IKEMIYA, Osaka (JP); Yosuke MATSUSHITA, Osaka (JP); Keisuke NAGATA, Osaka (JP); Mitsuteru KATAOKA, Osaka (JP)

(73) Assignee: Panasonic Automotive Systems Co., Ltd., Kanagawa (JP)

(21) Appl. No.: 19/029,894

(22) Filed: Jan. 17, 2025

(30) Foreign Application Priority Data
Jan. 31, 2024 (JP) 2024-013339

(51) Int. Cl. G07C 5/04; G07C 5/00

(52) U.S. Cl. CPC G07C 5/04; G07C 5/008

(57) ABSTRACT

A driving assistance system includes: a driving scene detector that detects a driving scene of a vehicle according to an output from one or more sensors provided in the vehicle; a cognitive action detector that detects a cognitive action of a driver who drives the vehicle, according to an output from one or more sensors provided in the vehicle; and a risk determiner that determines a degree of risk of driving of the vehicle by the driver, based on at least the driving scene detected and the cognitive action detected.

### CROSS REFERENCE TO RELATED APPLICATION

The present application is based on and claims priority of Japanese Patent Application No. 2024-013339 filed on Jan. 31, 2024.

### FIELD

The present disclosure relates to a system and the like that assist driving of a vehicle.

### BACKGROUND

Conventionally, a management assistance system has been proposed that assists management of the driving state of a driver who drives a vehicle (for example, refer to PTL 1). The management assistance system of PTL 1 includes an in-vehicle system provided in each vehicle owned by a carrier or the like, a server, and an administrator terminal. The in-vehicle system provided in a vehicle has an imaging device, a first monitoring device, and a second monitoring device. The imaging device images the front of the vehicle. The first monitoring device and the second monitoring device monitor the traveling state of the vehicle, and monitor the physical condition state of the driver of the vehicle while driving. Additionally, when those monitored results satisfy a predetermined condition, the in-vehicle system transmits, to the server, moving image information obtained by the imaging by the imaging device. The predetermined condition is, for example, a condition that the driving state of the driver is at a level requiring caution. Additionally, the moving image information transmitted to the server is information obtained by the imaging when the driving state of the driver is at the level requiring caution. Such moving image information is transmitted to the administrator terminal from the server.

Accordingly, a user of the administrator terminal, for example, an operation administrator of the above-described carrier, can identify how the vehicle has been driven by the driver in the driving state at the level requiring caution, by checking the moving image information. That is, the operation administrator can identify medical incidents, and can encourage the driver to improve the driving awareness. Note that, since the in-vehicle system included in the management assistance system is used for assistance of safe driving, the in-vehicle system may be called a driving assistance system.

### CITATION LIST

### Patent Literature

PTL 1: Japanese Patent No. 6714036

### SUMMARY

However, the in-vehicle system included in the management assistance system of PTL 1 described above, that is, the driving assistance system, can be improved upon.

In view of this, the present disclosure provides a driving assistance system and the like capable of improving upon the above related art.

A driving assistance system according to one aspect of the present disclosure includes: a driving scene detector that detects a driving scene of a vehicle according to an output from one or more sensors provided in the vehicle; a cognitive action detector that detects a cognitive action of a driver who drives the vehicle, according to an output from one or more sensors provided in the vehicle; and a risk determiner that determines a degree of risk of driving of the vehicle by the driver, based on at least the driving scene detected and the cognitive action detected.

Note that these general or specific aspects may be implemented using a device, a method, an integrated circuit, a computer program, or a computer-readable recording medium such as a compact disc read-only memory (CD-ROM), or any combination of devices, methods, integrated circuits, computer programs, or recording media. Moreover, the recording medium may be a non-transitory recording medium.

The driving assistance system according to the present disclosure is capable of improving upon the above related art.

Note that further advantage and effects in one aspect of the present disclosure will become apparent from the description and the drawings. Although such advantages and/or effects are provided by the configurations described in one or more embodiments, the description, and the drawings, not all the configurations are necessarily required.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram illustrating an example of the configuration of a management system including a driving assistance system in Embodiment 1.

FIG. 2 is a block diagram illustrating an example of the functional configuration of the driving assistance system in Embodiment 1.

FIG. 3 is a diagram illustrating an example of a driving scene detected by a driving scene detector in Embodiment 1.

FIG. 4 is a diagram illustrating another example of a driving scene detected by the driving scene detector in Embodiment 1.

FIG. 5 is a diagram illustrating a still another example of a driving scene detected by the driving scene detector in Embodiment 1.

FIG. 6 is a diagram illustrating a yet another example of a driving scene detected by the driving scene detector in Embodiment 1.

FIG. 7 is a diagram for describing detection of a cognitive action by a cognitive action detector in Embodiment 1.

FIG. 8 is a flowchart illustrating an example of the overall process operation of the driving assistance system in Embodiment 1.

FIG. 9 is a flowchart illustrating a detailed example of a scoring criterion selection process in Embodiment 1.

FIG. 10 is a flowchart illustrating a detailed example of a cognitive action scoring process in Embodiment 1.

FIG. 11 is a flowchart illustrating a detailed example of a vehicle behavior scoring process in Embodiment 1.

FIG. 12 is a block diagram illustrating an example of the functional configuration of a driving assistance system in Embodiment 2.

FIG. 13 is a diagram for describing the detection of a dangerous operation by a dangerous operation detector in Embodiment 2.

FIG. 14 is a diagram for describing the detection of visual observation of a vicinity object by a vicinity visual observation detector in Embodiment 2.

FIG. 15 is a flowchart illustrating an example of the overall process operation of a driving assistance system in Embodiment 2.

FIG. 16 is a flowchart illustrating a detailed example of a cognitive action scoring process and a vicinity visual observation scoring process in Example 1 of Embodiment 2.

FIG. 17 is a flowchart illustrating a detailed example of a vehicle behavior scoring process in Example 1 of Embodiment 2.

FIG. 18 is a flowchart illustrating a detailed example of a cognitive action scoring process and a vicinity visual observation scoring process in Example 2 of Embodiment 2.

FIG. 19 is a flowchart illustrating a detailed example of a vehicle behavior scoring process in Example 2 of Embodiment 2.

FIG. 20 is a flowchart illustrating a detailed example of a dangerous operation scoring process in Example 2 of Embodiment 2.

FIG. 21 is a flowchart illustrating a detailed example of a cognitive action scoring process in Example 3 of Embodiment 2.

FIG. 22 is a flowchart illustrating a detailed example of a vicinity visual observation scoring process in Example 3 of Embodiment 2.

FIG. 23 is a flowchart illustrating a detailed example of a vehicle behavior scoring process in Example 3 of Embodiment 2.

FIG. 24 is a flowchart illustrating a detailed example of a cognitive action scoring process in Example 4 of Embodiment 2.

FIG. 25 is a flowchart illustrating a detailed example of a vicinity visual observation scoring process in Example 4 of Embodiment 2.

FIG. 26 is a flowchart illustrating a detailed example of a vehicle behavior scoring process in Example 4 of Embodiment 2.

FIG. 27 is a flowchart illustrating a detailed example of a cognitive action scoring process in Example 5 of Embodiment 2.

FIG. 28 is a flowchart illustrating a detailed example of a vehicle behavior scoring process in Example 5 of Embodiment 2.

FIG. 29 is a flowchart illustrating a detailed example of a cognitive action scoring process in Example 6 of Embodiment 2.

FIG. 30 is a flowchart illustrating a detailed example of a vehicle behavior scoring process in Example 6 of Embodiment 2.

FIG. 31 is a block diagram illustrating an example of the functional configuration of a driving assistance system in Embodiment 3.

FIG. 32 is a diagram for describing an example of driving history data stored in a driving history storage in Embodiment 3.

FIG. 33 is a diagram illustrating a more specific example of the driving history data stored in the driving history storage in Embodiment 3.

FIG. 34 is a diagram for describing an example of the process operation of a time condition updater in Embodiment 3.

FIG. 35 is a flowchart illustrating an example of the overall process operation of a driving assistance system in Embodiment 3.

FIG. 36 is a flowchart illustrating an example of the process operation regarding the driving history by a risk determiner and an individual threshold value determiner in Embodiment 3.

FIG. 37 is a diagram illustrating an example of an accident history included in the driving history data in a variation of Embodiment 3.

FIG. 38 is a diagram for describing a conditional individual risk threshold value for a location in the variation of Embodiment 3.

FIG. 39 is a diagram illustrating another example of the accident history included in driving history data in the variation of Embodiment 3.

FIG. 40 is a flowchart illustrating an example of the process operation regarding the driving history by a risk determiner and an individual threshold value determiner in the variation of Embodiment 3.

FIG. 41 is a flowchart illustrating another example of the process operation regarding the driving history by the risk determiner and the individual threshold value determiner in the variation in Embodiment 3.

### DESCRIPTION OF EMBODIMENTS

A driving assistance system according to a first aspect of the present disclosure includes: a driving scene detector that detects a driving scene of a vehicle according to an output from one or more sensors provided in the vehicle; a cognitive action detector that detects a cognitive action of a driver who drives the vehicle, according to an output from one or more sensors provided in the vehicle; and a risk determiner that determines a degree of risk of driving of the vehicle by the driver, based on at least the driving scene detected and the cognitive action detected.

Accordingly, since the driving scene and the cognitive action are detected, and the degree of risk of driving of the vehicle by the driver is determined based on those detection results, the degree of risk can be appropriately determined. That is, even if the driver is in a good physical condition, when the cognitive action required for the driving scene, for example, the cognitive action such as visually observing the left direction when turning left at an intersection, is not performed, a high risk can be determined for driving at the driving scene. In other words, it is possible to appropriately determine whether or not unsafe driving has been performed. That is, the driving assistance system of PTL 1 described above has a problem that the degree of risk of driving of the vehicle by the driver may not be appropriately determined. That is, in the driving assistance system of PTL 1 described above, although the physical condition state of the driver is monitored as the driving state, the cognitive action of the driver is not monitored. Accordingly, even if a cognitive action required for driving is not performed, when the physical condition of the driver is good, since the driving state of the driver is not determined to be at the level requiring caution, there is a possibility that a medical incident is overlooked. However, the driving assistance system according to the first aspect can appropriately determine the degree of risk of driving of a vehicle by a driver.

Moreover, in the driving assistance system according to a second aspect, the risk determiner may determine the degree of risk by performing scoring of driving of the vehicle by the driver, and a driving score may be smaller when the degree of risk is higher, the driving score being a score obtained by the scoring. Note that the second aspect may depend from the first aspect.

Accordingly, since the degree of risk is determined by scoring of the driving score, the degree of risk can be evaluated in an easy-to-understand manner.

Moreover, in the driving assistance system according to a third aspect, the risk determiner may further determine whether or not the driving score is less than a risk threshold value, and the driving assistance system may further include: an uploader that uploads, to a server, driving video data obtained by imaging in the driving scene, when it is determined that the driving score is less than the risk threshold value. Note that the third aspect may depend from the second aspect.

Accordingly, since the driving movie data of a low driving score, that is, the driving video data at the time when unsafe driving has been performed, is uploaded to the server, the driver of the vehicle or an administrator who manages the vehicle can access the server to check the driving video data. As a result, the driver or the administrator can recognize the unsafe driving, and can achieve improvement of the awareness of safe driving. That is, after the end of work involving driving of the vehicle by the driver, the driver or the administrator can perform a review of the work by checking the driving video data, that is, the video at the time when the unsafe driving has been performed.

Moreover, the driving assistance system according to a fourth aspect may further include: a moving image editor that generates, from one or more items of moving image data obtained by imaging with a camera provided in the vehicle, the driving video data by selecting and editing a portion corresponding to the driving scene detected by the driving scene detector. Note that the fourth aspect may depend from the third aspect.

Accordingly, for example, for each predefined recording time period, even when the moving image data for the predetermined recording time period is output from the camera, only the portions corresponding to a driving scene are extracted from the one or more items of output moving image data, and are uploaded as the driving video data. In a specific example, the recording time period is one minute. Accordingly, it is possible to prevent uploading, to the server, of the moving image data showing scenes different from the detected driving scene, or even a part of the moving image data. As a result, the transmission load of useless data can be suppressed. Furthermore, when the driving scene is shown across a plurality of items of moving image data, the plurality of items of moving image data can be edited into one item of driving video data. As a result, since the video of the driving scene is displayed without interruption by reproduction of the driving video data, the video of the driving scene can be appropriately checked.

Moreover, in the driving assistance system according to a fifth aspect may further include: a vicinity detector that detects a movable object in a vicinity of the vehicle, according to an output from one or more sensors provided in the vehicle. The risk determiner determines the degree of risk based on a detection result of the movable object by the vicinity detector. Note that the fifth aspect may depend from any one of the first to fourth aspects. Note that the movable object may be, for example, a person, a bicycle, a motorcycle, or other vehicles. Moreover, the vicinity of the vehicle may be within a radius of R meters from the vehicle. R may be any numerical value.

Accordingly, when there is a movable object in the vicinity of the vehicle, a high degree of risk can be determined, and when there is no movable object in the vicinity of the vehicle, a low degree of risk can be determined. That is, when there is a person or the like in the vicinity of the vehicle, since danger is increased, a high degree of risk can be determined. As a result, the degree of risk can be determined more appropriately.

Moreover, in the driving assistance system according to a sixth aspect may further include: a vicinity visual observation detector that detects visual observation by the driver of one or more objects in a vicinity of the vehicle, according to an output from one or more sensors provided in the vehicle. The risk determiner may determine the degree of risk based on a detection result of the visual observation by the vicinity visual observation detector. Note that the sixth aspect may depend from any one of the first to fifth aspects. Note that the one or more objects may be an opposite lane or a movable object such as an oncoming vehicle.

Accordingly, for example, in a driving scene in which the vehicle turns right at an intersection, the degree of risk can be determined according to whether or not the driver has visually observed the opposite lane or an oncoming vehicle. That is, when visual observation has not been performed, a high degree of risk can be determined, and conversely, when visual observation has been performed, a low degree of risk can be determined. As a result, the degree of risk can be determined more appropriately.

Moreover, the driving assistance system according to a seventh aspect may further include: a vehicle behavior detector that detects behavior of the vehicle. The risk determiner determines the degree of risk based on a detection result of the behavior by the vehicle behavior detector. Note that the seventh aspect may depend from any one of the first to sixth aspects.

Accordingly, for example, in a driving scene in which the vehicle turns left at an intersection, the degree of risk can be determined according to whether or not the vehicle has traveled slowly. That is, when slow traveling has not been performed, a high degree of risk can be determined, and conversely, when slow traveling has been performed, a low degree of risk can be determined. As a result, the degree of risk can be determined more appropriately.

Moreover, the driving assistance system according to an eighth aspect may further include: a dangerous operation detector that detects a predetermined device operation by the driver as a dangerous operation, according to an output from one or more sensors provided in the vehicle. The risk determiner may determine the degree of risk based on a detection result of the dangerous operation by the dangerous operation detector. Note that the eighth aspect may depend from any one of the first to seventh aspects.

Accordingly, for example, in a driving scene in which the vehicle turns right at an intersection, the degree of risk can be determined according to whether or not the driver has performed an operation of a smartphone or the like as a dangerous operation. That is, when the dangerous operation has not been performed, a low degree of risk can be determined, and conversely, when the dangerous operation has been performed, a high degree of risk can be determined. As a result, the degree of risk can be determined more appropriately.

Moreover, in the driving assistance system according to a ninth aspect, when the risk determiner determines that the driving score is less than the risk threshold value, the risk determiner further: selects, from a plurality of individual risk threshold values, an individual risk threshold value associated with the driver; and determines whether or not the driving score is less than the selected individual risk threshold value, and the uploader uploads the driving video data to the server when the driving score is less than the risk threshold value and is less than the individual risk threshold value. Note that the ninth aspect may depend from any one of the fourth to eighth aspects that depend from the third aspect.

Accordingly, even in a case where the driving score is less than the risk threshold value, when the driving score is not less than the individual risk threshold value associated with the driver, uploading of the driving video data is not performed. Accordingly, even when unsafe driving has been performed by the driver, whether or not uploading of the driving video data is performed can be switched according to the driver. For example, a small individual risk threshold value is associated with an experienced driver who usually performs safe driving. As a result, even when the driver happens to perform unsafe driving, uploading of the driving video data can be prevented. Therefore, optimization of the uploading according to drivers can be achieved. By associating a small individual risk threshold value with an experienced driver who has been performing safe driving over many years (that is, an experienced safe driver), the driving video data can be less likely to be uploaded. On the other hand, by associating a large individual risk threshold value with an experienced driver who has been performing dangerous driving over many years (that is, an experienced dangerous driver), the driving video data can be more likely to be uploaded. As a result, optimization and improvement of efficiency of uploading of the driving video data can be achieved.

Moreover, in the driving assistance system according to a tenth aspect may further include: an individual threshold value determiner that determines, based on driving histories of a plurality of persons, each of the plurality of individual risk threshold values corresponding to the plurality of persons. Note that the tenth aspect may depend from the ninth aspect.

Accordingly, for each of the plurality of persons, the individual risk threshold value can be determined according to the person's type as a driver (that is, the driver type).

Moreover, in the driving assistance system according to an eleventh aspect, in determination of the plurality of individual risk threshold values, the individual threshold value determiner may determine, for each of a plurality of combinations, the individual risk threshold value corresponding to the combination, each of the plurality of combinations is a combination including one of the plurality of persons including the driver, and one of a plurality of driving scenes, and in selection of the individual risk threshold value, the risk determiner may select, from the plurality of individual risk threshold values, the individual risk threshold value associated with a combination of the driver and the driving scene detected by the driving scene detector. Note that the eleventh aspect may depend from the tenth aspect.

Accordingly, since the individual risk threshold value corresponding to the driver who has performed unsafe driving, and to the driving scene in which the unsafe driving has been performed is selected and used, further optimization and improvement of efficiency of uploading of the driving video data can be achieved. For example, even if the driver is a driver who usually performs save driving, if the driver tends to perform unsafe driving in a driving scene of reverse parking, a large individual risk threshold value can be selected for the driver only when reverse parking is performed. As a result, the driving video data can be more likely to be uploaded only when reverse parking is performed.

Moreover, in the driving assistance system according to a twelfth aspect, in determination of the plurality of individual risk threshold values, the individual threshold value determiner may determine, for each of a plurality of combinations, the individual risk threshold value corresponding to the combination, each of the plurality of combinations is a combination including one of the plurality of persons including the driver, and one of a plurality of locations, and in selection of the individual risk threshold value, the risk determiner may select, from the plurality of individual risk threshold values, the individual risk threshold value associated with a combination of the driver and a location where the vehicle is travelling in the driving scene detected by the driving scene detector. Note that the twelfth aspect may depend from the tenth aspect or the eleventh aspect depending from the tenth aspect.

Accordingly, since the individual risk threshold value corresponding to the driver who has performed unsafe driving, and to the location in the driving scene in which the unsafe driving has been performed is selected and used, further optimization and improvement of efficiency of uploading of the driving video data can be achieved. For example, even if the driver is a driver who usually performs safe driving, if the driver tends to perform unsafe driving at the location of a highway, a large individual risk threshold value can be selected for the driver only while the vehicle is travelling on a highway. As a result, the driving video data can be more likely to be uploaded only while the vehicle is travelling on a highway.

Moreover, in the driving assistance system according to a thirteenth aspect may further include: a time condition determiner that determines, based on driving histories of a plurality of persons, a prescribed time period corresponding to each of the plurality of persons. In determination of the degree of risk, the risk determiner may: select a prescribed time period associated with the driver from a plurality of prescribed time periods determined by the time condition determiner, the plurality of prescribed time periods each being the prescribed time period; and determine the degree of risk by comparing a time period during which the cognitive action detected by the cognitive action detector has been performed with the prescribed time period. Note that the thirteenth aspect may depend from any one of the first to twelfth aspects.

Accordingly, since the prescribed time period according to the driver is selected, and the degree of risk is determined by comparison between the time period during which the cognitive action has been performed by the driver and the prescribed time period, the risk can be determined more appropriately. For example, an experienced driver and a novice driver tend to differ in the time period for a cognitive action required for safe driving (for example, the visual observation time period of the right direction). Therefore, the degree of risk of driving by the driver can be appropriately determined by using the prescribed time period according to the driver.

Hereinafter, embodiments will be described in detail with reference to the drawings.

Note that each embodiment described below illustrates a general or specific example. Therefore, numerical values, shapes, materials, structural elements, the arrangement and connection of the structural elements, steps, the order of the steps, etc., shown in the following embodiments are mere examples, and are not intended to limit the scope of the present disclosure. Note that the figures are schematic illustrations and are not necessarily precise depictions. Moreover, in the figures, structural elements that are essentially the same share like reference signs.

### Embodiment 1

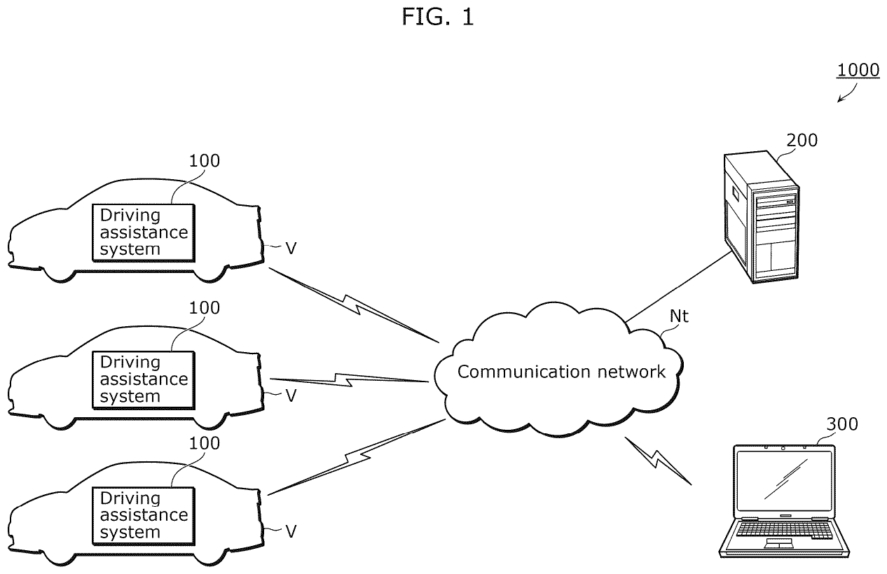

FIG. 1 is a diagram illustrating an example of the configuration of a management system including a driving assistance system in the present embodiment.

Management system 1000 is a system for managing a plurality of vehicles V, and includes a plurality of driving assistance systems 100, management server 200, and management terminal 300 that are connected to each other via communication network Nt.

Each of the plurality of driving assistance systems 100 is provided in vehicle V. The vehicle V may be a passenger car, or may be a commercial vehicle such as a taxi and a truck.

Management server 200 obtains and stores driving video data that is uploaded from each of the plurality of driving assistance systems 100. The driving video data shows unsafe driving of vehicle V that has uploaded the driving video data. Note that unsafe driving may be called dangerous driving.

Management terminal 300 is operated by an administrator who manages the plurality of vehicles V, accesses management server 200, and downloads the driving video data from management server 200. Additionally, the administrator, who is a user of management terminal 300, identifies what kind of unsafe driving is being performed by viewing the driving video data reproduced by management terminal 300, and takes a countermeasure for suppressing occurrence of the unsafe driving. Note that the driver of each of the plurality of vehicles V may operate management terminal 300 to reproduce the driving video data, and may check the unsafe driving shown in the driving video data.

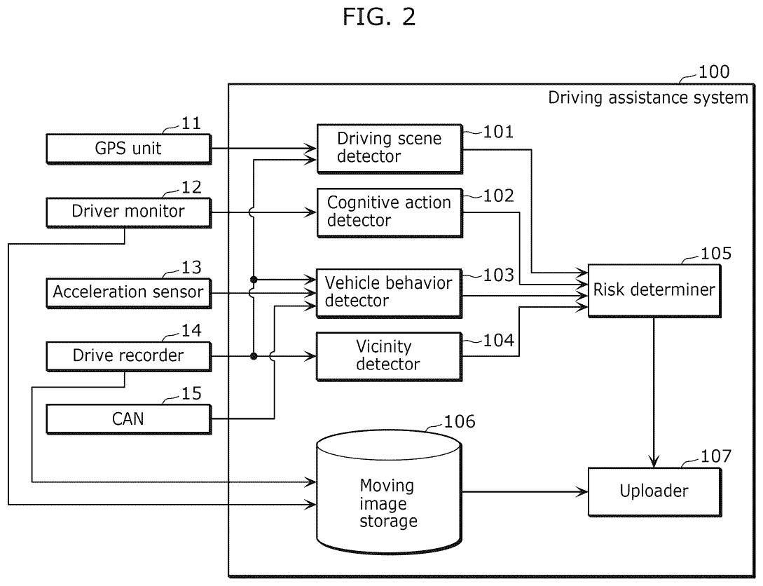

FIG. 2 is a block diagram illustrating an example of the functional configuration of driving assistance system 100 in the present embodiment.

Driving assistance system 100 assists driving of vehicle V according to the outputs from a plurality of sensors provided in vehicle V including driving assistance system 100. The assistance of driving is, for example, uploading of the above-described driving video data. The plurality of sensors include, for example, GPS (Global Positioning System) unit 11, driver monitor 12, acceleration sensor 13, drive recorder 14, and CAN (Controller Area Network) 15.

GPS unit 11 receives a signal from a GPS Satellite, specifies the position of vehicle V in which GPS unit 11 is provided, and outputs a position signal indicating the position of that vehicle V. Note that any sensor may be used instead of GPS unit 11, as long as the sensor specifies the position of vehicle V by a GNSS (Global Navigation Satellite System), and outputs the position signal indicating the position. Driver monitor 12 includes a camera that images the driver of vehicle V, and outputs the moving image data obtained by the imaging with the camera. Acceleration sensor 13 measures the acceleration of vehicle V, and outputs an acceleration signal indicating the acceleration. Drive recorder 14 (also referred to as a vehicle-mounted video recorder, for example) includes a camera that images the vicinity of vehicle V, and outputs the moving image data obtained by the imaging with the camera. CAN 15 is a communication network including, for example, a plurality of ECUs (Electronic Control Units) provided in vehicle V, and outputs a travelling signal indicating the traveling state, such as the vehicle speed and steering angle of vehicle V.

Driving assistance system 100 in the present embodiment includes driving scene detector 101, cognitive action detector 102, vehicle behavior detector 103, vicinity detector 104, risk determiner 105, moving image storage 106, and uploader 107.

Driving scene detector 101 detects a driving scene of vehicle V according to the output from one or more sensors provided in vehicle V. The one or more sensors are, for example, GPS unit 11, drive recorder 14, and the like. Note that the output from CAN 15 may be used for detection of a driving scene. Driving scenes are, for example, a left turn or right turn at an intersection, reverse parking in a parking lot, a lane change, and the like.

Cognitive action detector 102 detects the cognitive action of the driver who drives vehicle V, according to the output from one or more sensors provided in vehicle V. The one or more sensors include, for example, driver monitor 12. In addition, the cognitive action is the driver's visual observation, and more specifically is the position or direction to which the driver's line of sight is directed within vehicle V.

Vehicle behavior detector 103 detects the behavior of vehicle V, according to the output from one or more sensors provided in vehicle V. The one or more sensors are, for example, acceleration sensor 13, drive recorder 14, CAN 15, and the like. The behavior of vehicle V includes the vehicle speed, steering angle, and running position of vehicle V, and their changes. More specifically, the behavior of vehicle V may be slow traveling, sudden slowdown, sudden speeding up, an operation for lighting a direction indicator, movement to left or right, or the like.

Vicinity detector 104 detects an object in the vicinity of vehicle V as a vicinity object, according to the output from the one or more sensors provided in vehicle V. The detected vicinity object may be a movable object, such as a person, a bicycle, and another vehicle. In addition, vicinity detector 104 may determine the kind of the detected vicinity object, and may determine whether the vicinity object is a stationary object or a movable object. The kind of the vicinity object may be a vehicle, an oncoming car, a person, a bicycle, a truck, a parking space, or the like.

Risk determiner 105 determines the degree of risk of driving of vehicle V by the driver, based at least on the detected driving scene and cognitive action. In addition, in the present embodiment, risk determiner 105 determines the degree of risk not only based on the driving scene and the cognitive action, but also based on a detection result of the behavior of vehicle V by vehicle behavior detector 103. Specifically, risk determiner 105 determines the degree of risk by scoring the driving of vehicle V by the driver. The driving score, which is the score obtained by the scoring, is smaller when the degree of risk is higher. Furthermore, risk determiner 105 determines whether or not the driving score is less than a risk threshold value. When risk determiner 105 determines that the driving score is less than the risk threshold value, risk determiner 105 determines that driving of vehicle V is unsafe driving.

Moving image storage 106 is a recording medium for storing the moving image data obtained by the imaging with the camera included in each of driver monitor 12 and drive recorder 14. For example, moving image storage 106 is a hard disk drive, random access memory (RAM), read only memory (ROM), or semiconductor memory. Note that such moving image storage 106 may be volatile, or may be non-volatile.

Uploader 107 uploads, to management server 200, one or more items of moving image data obtained by the imaging in the detected driving scene, among one or more items of moving image data stored in moving image storage 106, as the driving video data. The driving scene is a driving scene at the time when the above-described unsafe driving has been performed. That is, when it is determined by risk determiner 105 that the driving score is less than the risk threshold value, uploader 107 uploads, to management server 200, the driving video data obtained by the imaging in the driving scene.

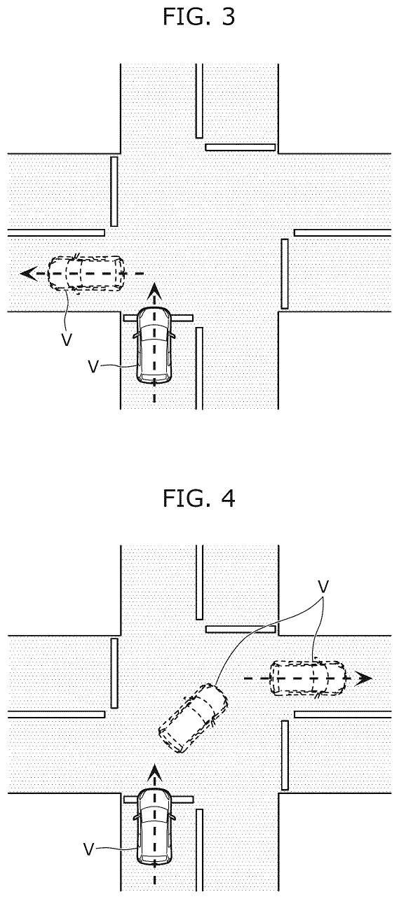

FIG. 3 is a diagram illustrating an example of a driving scene detected by driving scene detector 101.

Driving scene detector 101 detects a left turn at an intersection as a driving scene, as illustrated in FIG. 3. Specifically, driving scene detector 101 specifies the position and orientation of vehicle V on a map, based on at least one of the position signal that is output from GPS unit 11 or the moving image data that is output from drive recorder 14. Here, when driving scene detector 101 specifies that vehicle V has entered the intersection, and the moving direction of vehicle V has changed to, for example, the left by substantially 90 degrees, driving scene detector 101 detects a left turn at the intersection as a driving scene of vehicle V.

FIG. 4 is a diagram illustrating another example of a driving scene detected by driving scene detector 101.

Driving scene detector 101 detects a right turn at an intersection as a driving scene, as illustrated in FIG. 4. Specifically, driving scene detector 101 specifies that vehicle V has entered the intersection, and the moving direction of vehicle V has changed to, for example, the right by substantially 90 degrees, based on at least one of the position signal that is output from GPS unit 11 or the moving image data that is output from drive recorder 14. In this case, driving scene detector 101 detects a right turn at the intersection as a driving scene of vehicle V.

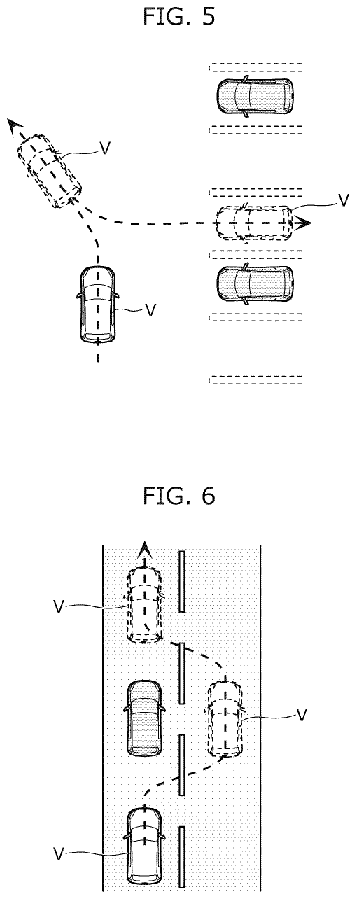

FIG. 5 is a diagram illustrating a still another example of a driving scene detected by driving scene detector 101.

Driving scene detector 101 detects reverse parking in a parking lot as a driving scene, as illustrated in FIG. 5. In addition, reverse parking is an operation in which vehicle V enters and stops in a parking space while backing up. Specifically, driving scene detector 101 specifies that vehicle V has entered the parking lot, based on at least one of the position signal that is output from GPS unit 11 or the moving image data that is output from drive recorder 14. Furthermore, driving scene detector 101 specifies a change in the moving direction of vehicle V of, for example, 90 degrees or more, a plurality of times of change of the moving direction, stopping after being switched from forward to backward, and the like. In this case, driving scene detector 101 detects reverse parking in a parking lot as a driving scene of vehicle V.

FIG. 6 is a diagram illustrating a yet another example of a driving scene detected by driving scene detector 101.

Driving scene detector 101 detects a lane change or overtaking as a driving scene, as illustrated in FIG. 6. Specifically, driving scene detector 101 specifies that vehicle V is travelling on a road including two or more lanes, based on at least one of the position signal that is output from GPS unit 11 or the moving image data that is output from drive recorder 14. Furthermore, driving scene detector 101 specifies that vehicle V has crossed a white line. In this case, driving scene detector 101 detects a lane change as a driving scene of vehicle V. Thereafter, driving scene detector 101 further specifies that vehicle V has crossed the above-described white line again, and has overtaken another vehicle, based on at least one of the position signal that is output from GPS unit 11 or the moving image data that is output from drive recorder 14. In this case, driving scene detector 101 detects an overtaking as a driving scene of vehicle V.

Note that, when driving scene detector 101 detects a right turn or left turn only from the moving image data, driving scene detector 101 may detect a white line, and perform detection of a right turn or left turn based on the pattern of detection of the white line. In the case of a left turn, a white line is detected in the moving direction, a white line is not detected in an intersection, and when a white line of a lane after the left turn begins to be detected, although the white line is detected diagonally with respect to the moving direction, the white line gradually matches the moving direction. The same applies to the case of a right turn, and the angle at which a white line is detected diagonally is reversed in a left-right direction with respect to the angle in the case of the left turn. When increasing accuracy, in a case where sound data is output along with moving image data, the sound data, specifically, the sound data of a direction indicator, may be utilized. When driving scene detector 101 detects backing up of vehicle V, driving scene detector 101 may utilize sound data indicating the sound that occurs at the time of backing up. Many vehicles generate the sound of a specific pattern in a time period during which a direction indicator is lit, and a time period during which backing up is being performed. In order to highly accurately detect the specific pattern, it is desirable to explicitly register, in driving assistance system 100 in advance, the moving image data and sound data at the time when a direction indicator is lit, or at the time when a gear is put in reverse.

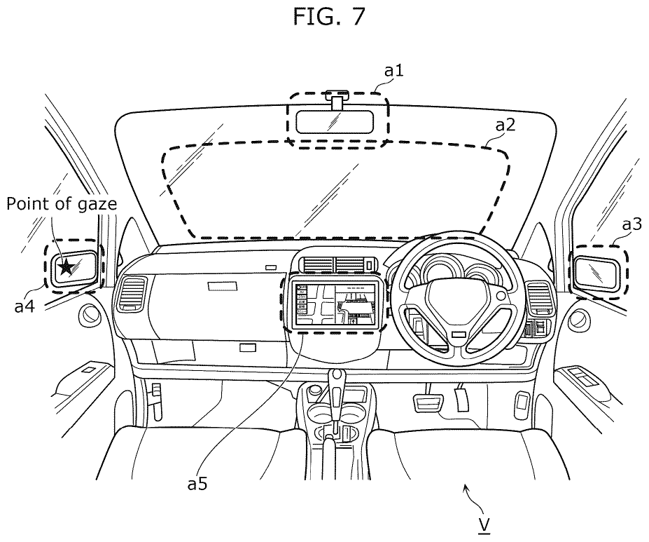

FIG. 7 is a diagram for describing detection of a cognitive action by cognitive action detector 102.

Cognitive action detector 102 specifies a point of gaze beyond the driver's line of sight, based on the moving image data that is output from driver monitor 12. Then, cognitive action detector 102 specifies a portion of vehicle V that overlaps with the point of gaze, or a portion of vehicle V that is in the vicinity of the point of gaze. As a result, cognitive action detector 102 detects that the driver has visually observed the specified portion as a cognitive action of the driver.

For example, as illustrated in FIG. 7, when the point of gaze has been in area a4, cognitive action detector 102 detects that the driver has visually observed a left mirror (also called a left door mirror) as a cognitive action of the driver. Note that area a4 is an area including the left mirror of vehicle V. Similarly, when the point of gaze has been in area a3, cognitive action detector 102 detects that the driver has visually observed a right mirror (also called a right door mirror) as a cognitive action of the driver. Note that area a3 is an area including the right mirror of vehicle V. In addition, when the point of gaze has been in area a1, cognitive action detector 102 detects that the driver has visually observed a rearview mirror as a cognitive action of the driver. Note that area a1 is an area including the rearview mirror of vehicle V. Furthermore, when the point of gaze has been in area a5, cognitive action detector 102 detects that the driver has visually observed a car navigation system (also called a car navigation device) as a cognitive action of the driver. Note that area a5 is an area including the car navigation system of vehicle V. In addition, when the point of gaze has been in area a2, cognitive action detector 102 detects that the driver has visually observed the front or a windshield of vehicle V as a cognitive action of the driver. Note that area a2 is an area including a part or whole of the windshield of vehicle V. Similarly, when the point of gaze has been in an area including a left glass window or a right glass window of vehicle V, cognitive action detector 102 detects that the driver has visually observed the left direction or right direction of vehicle V as a cognitive action of the driver.

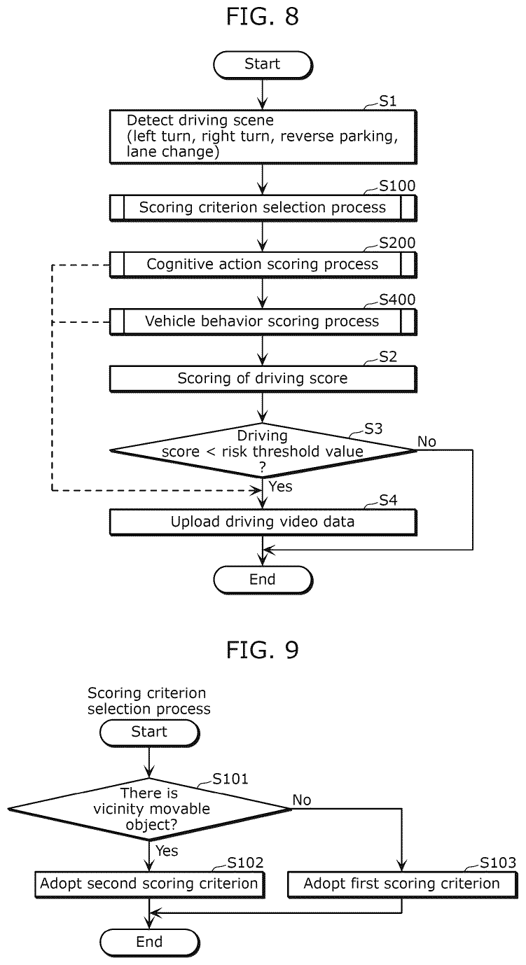

FIG. 8 is a flowchart illustrating an example of the overall process operation of driving assistance system 100 in the present embodiment.

First, driving scene detector 101 detects a driving scene of vehicle V (step S1). Next, risk determiner 105 performs a scoring criterion selection process based on the driving scene detected by driving scene detector 101 and a detection result of a vicinity object by vicinity detector 104 (step S100). This scoring criterion selection process is a process for selecting a scoring criterion for scoring the above-described driving score.

Next, risk determiner 105 performs a cognitive action scoring process based on the driving scene detected by driving scene detector 101 and a detection result of a cognitive action by cognitive action detector 102 (step S200). This cognitive action scoring process is a process for performing the scoring of the driving action score for the cognitive action of the detection scene, based on the scoring criterion selected in step S100.

Furthermore, risk determiner 105 performs a vehicle behavior scoring process based on the driving scene detected by driving scene detector 101 and a detection result of a behavior of vehicle V by vehicle behavior detector 103 (step S400). This vehicle behavior scoring process is a process for performing the scoring of the driving action score for the vehicle behavior of the detection scene, based on the scoring criterion selected in step S100. Note that driving assistance system 100 may perform the process in step S4 by the respective processes of steps S200 and S400. In addition, the respective processes of step S200 and step S400 may be performed in any order.

Then, risk determiner 105 determines the degree of risk of driving of vehicle V by the driver, based on the processing results of steps S200 and S400. That is, risk determiner 105 determines the degree of risk by performing the scoring of the driving of vehicle V by the driver (step S2). Specifically, risk determiner 105 performs the scoring of the driving score by performing weighted addition on the driving action score that is scored by each of step S200 and step S400.

Next, risk determiner 105 determines whether or not the driving score that is scored in step S2 is less than the risk threshold value (step S3). Here, when risk determiner 105 determines that the driving score is less than the risk threshold value (Yes in step S3), risk determiner 105 instructs uploader 107 to upload driving video data. As a result, uploader 107 uploads the driving video data to management server 200 (step S4). That is, uploader 107 extracts, from moving image storage 106, the driving video data obtained by the imaging in the driving scene detected in step S1, and uploads the driving video data to management server 200. Note that the driving video data includes one or more items of moving image data that is output from the camera of driver monitor 12, and one or more items of moving image data that is output from the camera of drive recorder 14.

On the other hand, when risk determiner 105 determines that the driving score is not less than the risk threshold value (No in step S3), that is, when risk determiner 105 determines that the driving score is equal to or larger than the risk threshold value, risk determiner 105 ends the process for the driving scene detected in step S1, without instructing the uploading.

FIG. 9 is a flowchart illustrating a detailed example of the scoring criterion selection process. Note that FIG. 9 illustrates detailed processes in step S100 in FIG. 8.

Risk determiner 105 determines whether or not there is a movable object (hereinafter also called a vicinity movable object) in the vicinity of vehicle V, based on a detection result of a vicinity object by vicinity detector 104 (step S101). As described above, the vicinity movable object is, for example, a person, a bicycle, another vehicle, or the like. Such a vicinity movable object may be a movable object defined in advance for each driving scene detected in step S100. For example, when a driving scene is a right turn at an intersection, a vicinity movable object may be an oncoming car, and when a driving scene is a right turn, a vicinity movable object may be a person, a bicycle, or the like.

Then, when risk determiner 105 determines that there is no vicinity movable object in step S101 (No in step S101), risk determiner 105 adopts a first scoring criterion (step S103). On the other hand, when risk determiner 105 determines that there is a vicinity movable object in step S101 (Yes in step S101), risk determiner 105 adopts a second scoring criterion (S102). Note that each of the first scoring criterion and the second scoring criterion is a criterion for scoring the driving score, that is, a criterion for determining the degree of risk of driving. Note that, the second scoring criterion may adopt a lower score for the same driving than the first scoring criterion. In other words, the second scoring criterion is a scoring criterion stricter than the first scoring criterion.

In this manner, in the present embodiment, risk determiner 105 determines the degree of risk based on the detection result of the movable object by vicinity detector 104. Accordingly, when there is a movable object in the vicinity of vehicle V, it is possible to determine a high degree of risk, that is, to score a low driving score. Conversely, when there is no movable object in the vicinity of vehicle V, it is possible to determine a low degree of risk, that is, to score a high driving score. That is, when there is a person or the like in the vicinity of vehicle V, since danger is increased, a high degree of risk can be determined. As a result, the degree of risk can be determined more appropriately.

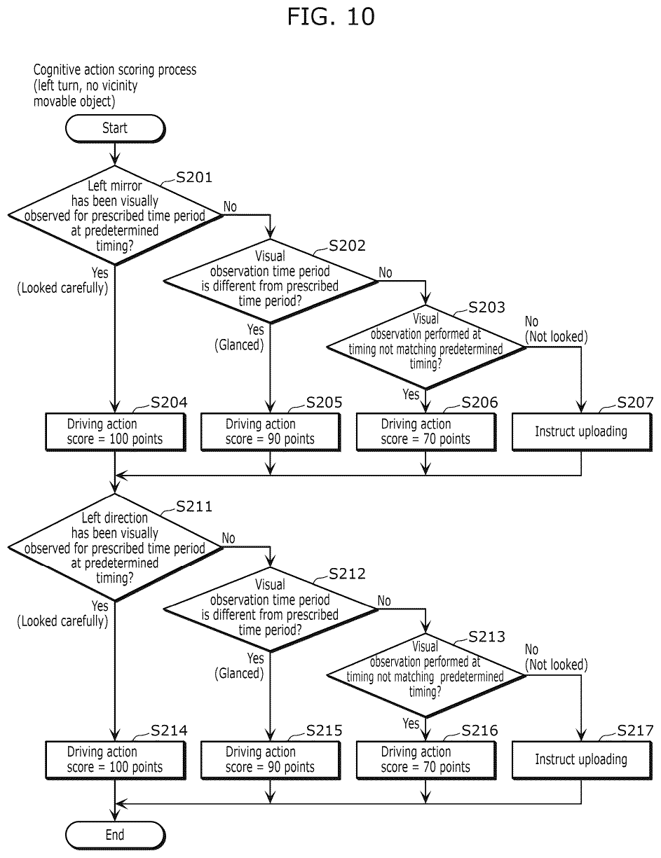

FIG. 10 is a flowchart illustrating a detailed example of the cognitive action scoring process. Note that FIG. 10 illustrates detailed processes in step S200 in FIG. 8 in a case where a left turn at an intersection is detected as a driving scene in step S1 in FIG. 8, and the first scoring criterion is adopted in step S100 in FIG. 8 (specifically, step S103 in FIG. 9). That is, FIG. 10 illustrates a detailed example of the cognitive action scoring process in the case where the left turn is performed when there is no vicinity movable object.

### <Checking Left Mirror>

First, risk determiner 105 determines whether or not the driver has visually observed a left mirror of vehicle V for a prescribed time period at a predetermined timing, based on the detection result of the cognitive action by cognitive action detector 102 (step S201). Note that the predetermined timing may be timing from the start to the end of a change in the moving direction of vehicle V by substantially 90 degrees, or may be timing from n seconds (n is any integer of 0 or more) before vehicle V enters an intersection until vehicle V passes through the intersection. In addition, the prescribed time period may be a time period within a range from predefined time ta1 to predefined time ta2 (ta2>ta1). Here, when risk determiner 105 determines that the driver has visually observed the left mirror of vehicle V for the prescribed time period at the predetermined timing (Yes in step S201), risk determiner 105 determines the driving action score for the cognitive action of the left mirror to be 100 points (step S204).

On the other hand, when risk determiner 105 determines that the driver has not visually observed the left mirror of vehicle V for the prescribed time period at the predetermined timing (No in step S201), risk determiner 105 determines whether or not the driver has visually observed the left mirror for a time period that is different from the prescribed time period at the predetermined timing (step S202). Here, when risk determiner 105 determines that the driver has visually observed the left mirror for the time period that is different from the prescribed time period at the predetermined timing (Yes in step S202), risk determiner 105 determines the driving action score for the cognitive action of the left mirror to be 90 points (step S205). For example, when the driver has glanced at the left mirror at the predetermined timing, 90 points is determined.

On the other hand, when risk determiner 105 determines that the driver has not visually observed the left mirror for the time period that is different from the prescribed time period at the predetermined timing (No in step S202), risk determiner 105 determines whether or not visual observation of the left mirror has been performed at a timing that does not match the predetermined timing (step S203). Here, when risk determiner 105 determines that the visual observation of the left mirror has been performed at the timing that does not match the predetermined timing (Yes in step S203), risk determiner 105 determines the driving action score for the cognitive action of the left mirror to be 70 points (step S206). On the other hand, when risk determiner 105 determines that the visual observation of the left mirror has not been performed at the timing that does not match the predetermined timing (No in step S203), risk determiner 105 instructs uploader 107 to upload driving video data (step S207). For example, when the driver has not looked at the left mirror, the uploading is instructed. As a result, the process in step S4 in FIG. 8 is performed.

### <Checking Left Direction>

Furthermore, risk determiner 105 determines whether or not the driver has visually observed the left direction of vehicle V for a prescribed time period at a predetermined timing, based on the detection result of the cognitive action by cognitive action detector 102 (step S211). The predetermined timing and the prescribed time period may be the same as or different from the predetermined timing and the prescribed time period in step S201. Here, when risk determiner 105 determines that the driver has visually observed the left direction of vehicle V for the prescribed time period at the predetermined timing (Yes in step S211), risk determiner 105 determines the driving action score for the cognitive action of the left direction to be 100 points (step S214).

On the other hand, when risk determiner 105 determines that the driver has not visually observed the left direction of vehicle V for the prescribed time period at the predetermined timing (No in step S211), risk determiner 105 determines whether or not the driver has visually observed the left direction for a time period that is different from the prescribed time period at the predetermined timing (step S212). Here, when risk determiner 105 determines that the driver has visually observed the left direction for the time period that is different from the prescribed time period at the predetermined timing (Yes in step S212), risk determiner 105 determines the driving action score for the cognitive action of the left direction to be 90 points (step S215). For example, when the driver has glanced at the left mirror at the predetermined timing, 90 points is determined.

On the other hand, when risk determiner 105 determines that the driver has not visually observed the left direction for the time period that is different from the prescribed time period at the predetermined timing (No in step S212), risk determiner 105 determines whether or not visual observation of the left direction has been performed at a timing that does not match the predetermined timing (step S213). Here, when risk determiner 105 determines that the visual observation of the left direction has been performed at the timing that does not match the predetermined timing (Yes in step S213), risk determiner 105 determines the driving action score for the cognitive action of the left direction to be 70 points (step S216). On the other hand, when risk determiner 105 determines that the visual observation of the left direction has not been performed at the timing that does not match the predetermined timing (No in step S213), risk determiner 105 instructs uploader 107 to upload driving video data (step S217). For example, when the driver has not looked at the left direction, the uploading is instructed. As a result, the process in step S4 in FIG. 8 is performed.

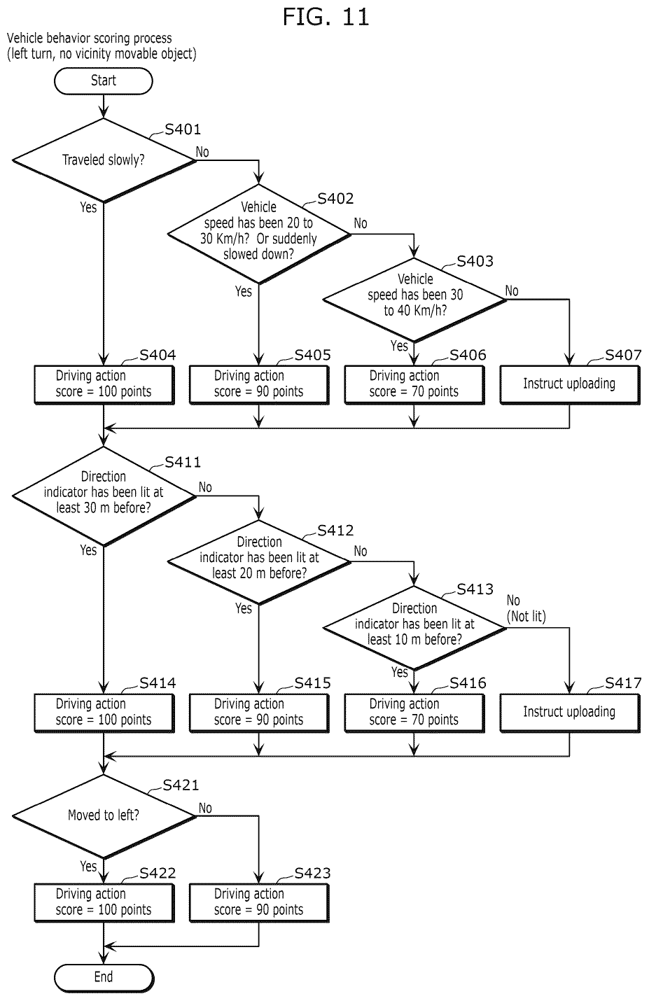

FIG. 11 is a flowchart illustrating a detailed example of the vehicle behavior scoring process. Note that FIG. 11 illustrates detailed processes in step S400 in FIG. 8 in a case where the left turn at the intersection is detected as the driving scene in step S1 in FIG. 8, and the first scoring criterion is adopted in step S100 in FIG. 8 (specifically, step S103 in FIG. 9). That is, FIG. 11 illustrates a detailed example of the vehicle behavior scoring process in the case where the left turn is performed when there is no vicinity movable object.

### <Slowing Down>

First, risk determiner 105 determines whether or not vehicle V has traveled slowly, based on the detection result of the behavior of vehicle V by vehicle behavior detector 103 (step S401). For example, risk determiner 105 determines that vehicle V has traveled slowly, when vehicle V has traveled at equal to or less than 10 km/h or 20 km/h. Here, when risk determiner 105 determines that vehicle V has traveled slowly (Yes in step S401), risk determiner 105 determines the driving action score for the vehicle speed to be 100 points (step S404).

On the other hand, when risk determiner 105 determines that vehicle V has not traveled slowly (No in step S401), risk determiner 105 determines whether or not vehicle V has traveled faster than 20 km/h and equal to or less than 30 km/h, or whether or not vehicle V has suddenly slowed down (step S402). Here, when risk determiner 105 determines that vehicle V has traveled faster than 20 km/h and equal to or less than 30 km/h, or determines that vehicle V has suddenly slowed down (Yes in step S402), risk determiner 105 determines the driving action score for the vehicle speed to be 90 points (step S405). Note that, when the negative acceleration of vehicle V is equal to or less than a predefined lower limit value, it is determined that vehicle V has suddenly slowed down.

On the other hand, when risk determiner 105 determines that vehicle V has not traveled faster than 20 km/h and equal to or less than 30 km/h, and vehicle V has not suddenly slowed down (No in step S402), risk determiner 105 determines whether or not vehicle V has traveled faster than 30 km/h and equal to or less than 40 km/h (step S403). Here, when risk determiner 105 determines that vehicle V has traveled faster than 30 km/h and equal to or less than 40 km/h (Yes in step S403), risk determiner 105 determines the driving action score for the vehicle speed to be 70 points (step S406). On the other hand, when risk determiner 105 determines that vehicle V has not traveled faster than 30 km/h and equal to or less than 40 km/h (No in step S403), risk determiner 105 instructs uploader 107 to upload driving video data (step S407). For example, when vehicle V has traveled at a speed faster than 40 km/h, the uploading is instructed. As a result, the process in step S4 in FIG. 8 is performed.

### <Direction Indication>

Furthermore, risk determiner 105 determines whether or not vehicle V has lit a direction indicator (that is, a blinker) at least 30 m before the intersection, based on the detection result of the behavior of vehicle V by vehicle behavior detector 103 (step S411). Here, when risk determiner 105 determines that vehicle V has lit the direction indicator (Yes in step S411), risk determiner 105 determines the driving action score for the direction indication to be 100 points (step S414).

On the other hand, when risk determiner 105 determines that vehicle V has not lit the direction indicator at least 30 m before the intersection (No in step S411), risk determiner 105 determines whether or not vehicle V has lit the direction indicator at least 20 m before the intersection (step S412). Here, when risk determiner 105 determines that vehicle V has lit the direction indicator (Yes in step S412), risk determiner 105 determines the driving action score for the direction indication to be 90 points (step S415).

On the other hand, when risk determiner 105 determines that vehicle V has not lit the direction indicator at least 20 m before the intersection (No in step S412), risk determiner 105 determines whether or not vehicle V has lit the direction indicator at least 10 m before the intersection (step S413). Here, when risk determiner 105 determines that vehicle V has lit the direction indicator (Yes in step S413), risk determiner 105 determines the driving action score for the direction indication to be 70 points (step S416). On the other hand, when risk determiner 105 determines that vehicle V has not lit the direction indicator at least 10 m before the intersection (No in step S413), risk determiner 105 instructs uploader 107 to upload driving video data (step S417). As a result, the process in step S4 in FIG. 8 is performed.

### <Movement to Left Side>

Furthermore, risk determiner 105 determines whether or not vehicle V has moved to the left side before turning left, based on the detection result of the behavior of vehicle V by vehicle behavior detector 103 (step S421). Here, when risk determiner 105 determines that vehicle V has moved to the left side (Yes in step S421), risk determiner 105 determines the driving action score for the movement to the left side to be 100 points (step S422). On the other hand, when risk determiner 105 determines that vehicle V has not moved to the left side (No in step S421), risk determiner 105 determines the driving action score for the movement to the left side to be 90 points (step S423).

As a result, in step S2 in FIG. 8, risk determiner 105 calculates the driving score for the driving of vehicle V by the driver, by performing weighted addition on the driving action score for each of the cognitive action of the left mirror, the cognitive action of the left direction, the vehicle speed, the direction indication, and the movement to the left side. For example, each of the above-described driving action scores is on a scale of 100 points, and risk determiner 105 performs weighted addition on those driving action scores, so that the full marks of the driving score becomes 100. In addition, each driving action score may be weighted equally.

Here, in FIG. 10 and FIG. 11, the examples of the cognitive action scoring process and the vehicle behavior scoring process in the case where the first scoring criterion is adopted in the situation without a vicinity movable object are illustrated. On the other hand, in a situation with a vicinity movable object, as illustrated in FIG. 9, the second scoring criterion is adopted. Accordingly, in the situation with a vicinity movable object, a driving action score lower than that in the examples in FIG. 10 and FIG. 11 is adopted in the cognitive action scoring process and the vehicle behavior scoring process.

In this manner, in the present embodiment, since a driving scene and a cognitive action are detected, and the degree of risk of the driving of vehicle V by the driver is determined based on those detection results, the degree of risk can be appropriately determined. That is, even if the physical condition of the driver is good, when a cognitive action required for a driving scene, for example, a cognitive action such as visual observation of the left direction at a left turn at an intersection, has not been performed, a large risk can be determined for the driving in the driving scene. In other words, it is possible to appropriately determine whether or not unsafe driving has been performed.

In addition, in the present embodiment, since the degree of risk is determined by scoring of the driving score, the degree of risk can be evaluated in an easy-to-understand manner.

In addition, in the present embodiment, the driving movie data of a low driving score, that is, the driving video data at the time when unsafe driving has been performed, is uploaded to management server 200. Accordingly, the administrator who manages vehicle V (that is, the user of management terminal 300) can access management server 200 from management terminal 300 to check the driving video data. As a result, the administrator can recognize the unsafe driving, and can achieve improvement of the awareness of safe driving.

In addition, in the present embodiment, the degree of risk is determined based on the detection result of the behavior of vehicle V by vehicle behavior detector 103. Accordingly, for example, in a driving scene in which vehicle V turns left at an intersection, the degree of risk can be determined according to whether or not vehicle V has traveled slowly. That is, when slow traveling has not been performed, a high degree of risk can be determined, and conversely, when slow traveling has been performed, a low degree of risk can be determined. As a result, the degree of risk can be determined more appropriately.

### Embodiment 2

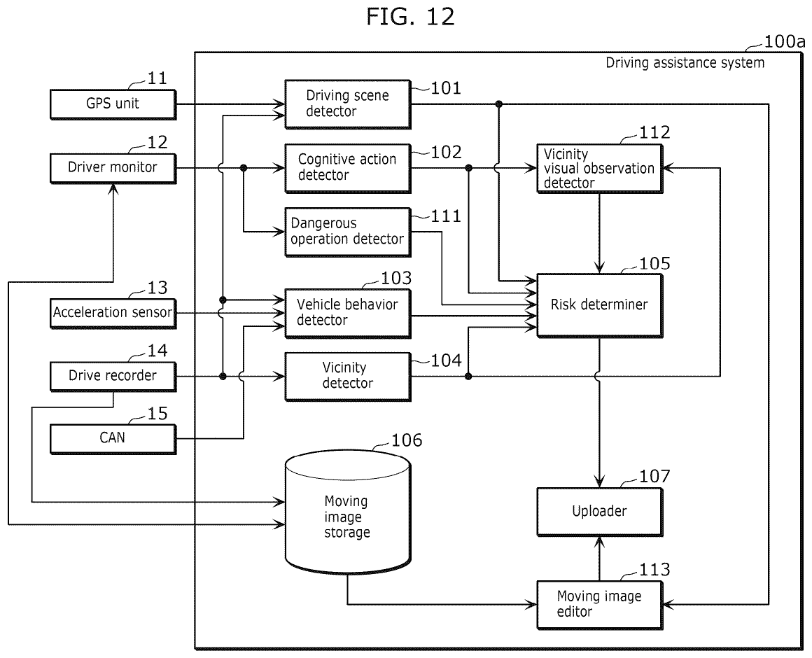

FIG. 12 is a block diagram illustrating an example of the functional configuration of the driving assistance system in the present embodiment.

Driving assistance system 100a in the present embodiment includes each of the structural elements of driving assistance system 100 in Embodiment 1, and further includes dangerous operation detector 111, vicinity visual observation detector 112, and moving image editor 113.

Dangerous operation detector 111 detects a predetermined device operation by the driver as a dangerous operation, according to the outputs from one or more sensors provided in vehicle V. The one or more sensors include, for example, the camera of driver monitor 12.

Vicinity visual observation detector 112 detects visual observation by the driver of one or more objects in the vicinity of vehicle V, according to the outputs from one or more sensors provided in vehicle V. The one or more sensors are, for example, respective cameras of driver monitor 12 and drive recorder 14. Specifically, vicinity visual observation detector 112 obtains the detection result of a cognitive action by cognitive action detector 102 for the moving image data that is output from the camera of driver monitor 12. Furthermore, vicinity visual observation detector 112 obtains the detection result of a vicinity object by vicinity detector 104 for the moving image data that is output from the camera of drive recorder 14. Then, vicinity visual observation detector 112 detects the visual observation by the driver for one or more objects in the vicinity of vehicle V, based on the detection result of the cognitive action, and the detection result of the vicinity object. The one or more objects in the vicinity of vehicle V are one or more vicinity objects detected by vicinity detector 104. That is, vicinity visual observation detector 112 detects the driver's visual observation of the vicinity object, when the driver's point of gaze overlaps with the detected vicinity object or the bounding box surrounding the vicinity object.

Risk determiner 105 in the present embodiment determines the degree of risk based not only on the respective detection results of the cognitive action and the behavior of vehicle V, but also on the detection result of the dangerous operation by dangerous operation detector 111, and the detection result of the visual observation by vicinity visual observation detector 112.

Moving image editor 113 generates driving video data by selecting and editing the portions corresponding to driving scenes detected by driving scene detector 101 from one or more items of moving image data obtained by the imaging by the camera provided in vehicle V. The camera provided in vehicle V is the camera of at least one of driver monitor 12 or drive recorder 14. For each predetermined recording time period, such a camera continuously outputs and stores, in moving image storage 106, the moving image data obtained by imaging for the recording time period. The recording time period is, for example, 1 minute. When the moving image of the driving scene detected by driving scene detector 101 is shown across a plurality of items of moving image data, moving image editor 113 generates one item of driving video data by combining the plurality of items of moving image data. In addition, when the moving image of the above-described driving scene is not shown in a beginning portion of the first item of moving image data of the plurality of items of moving image data, moving image editor 113 may delete the beginning portion from the moving image data. Similarly, when the moving image of the above-described driving scene is not shown in an end portion of the last item of moving image data of the plurality of items of moving image data, moving image editor 113 may delete the end portion from the moving image data. Alternatively, when the moving image of the driving scene detected by driving scene detector 101 is shown only in a part of one item of moving image data, moving image editor 113 may generate driving video data by extracting the part from the one item of moving image data.

For example, in a driving scene of a left turn or right turn at an intersection, moving image editor 113 generates driving video data showing the moving image in the time period during which vehicle V travels from 60 m before a change point in the moving direction (that is, the vector) of vehicle V to 20 m beyond of the change point. Note that the change point is a point at which the moving direction is changed by substantially 90 degrees. Alternatively, in the driving scene, moving image editor 113 generates driving video data showing the moving image in a time period from 5 seconds before vehicle V arrives at the change point in the moving direction of vehicle V until vehicle V passes the change point and 3 seconds elapses. In addition, in a driving scene of reverse parking, moving image editor 113 generates driving video data showing the moving image in the time period during which vehicle V travels from 30 m before the change point in the moving direction of vehicle V to 10 m beyond the change point. Alternatively, in the driving scene, moving image editor 113 generates driving video data showing the moving image in the time period from 3 seconds before vehicle V arrives at the change point in the moving direction of vehicle V until vehicle V passes the change point and 1 second elapses. In addition, in a driving scene of a lane change, moving image editor 113 generates driving video data showing the moving image in the time period from 5 seconds before vehicle V crosses a white line until 5 seconds elapses after vehicle V crosses the white line. Note that the above-described numerical values, such as meters and seconds, are examples, and may be other numerical values.

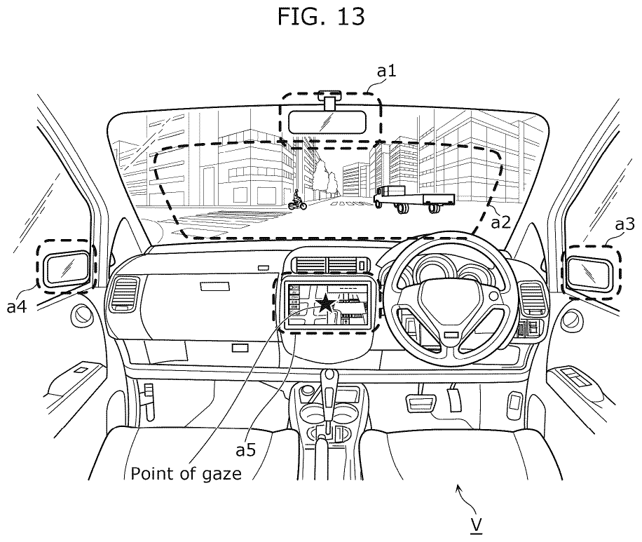

FIG. 13 is a diagram for describing the detection of a dangerous operation by dangerous operation detector 111.

Dangerous operation detector 111 specifies the point of gaze beyond the driver's line of sight, based on the moving image data that is output from driver monitor 12. Additionally, as illustrated in FIG. 13, when the point of gaze has been in area a5, and the driver's hand or finger is shown in area a5 during driving, dangerous operation detector 111 detects the operation of the car navigation system by the driver as a dangerous operation. Alternatively, when the point of gaze has been in an area where there is the driver's smartphone, and the driver's hand or finger is shown in the area during driving, dangerous operation detector 111 detects the operation of the smartphone by the driver as a dangerous operation. Note that, according to a driving scene detected by driving scene detector 101, dangerous operation detector 111 may detect the operation of the car navigation or the smartphone by the driver in the driving scene as a dangerous operation.

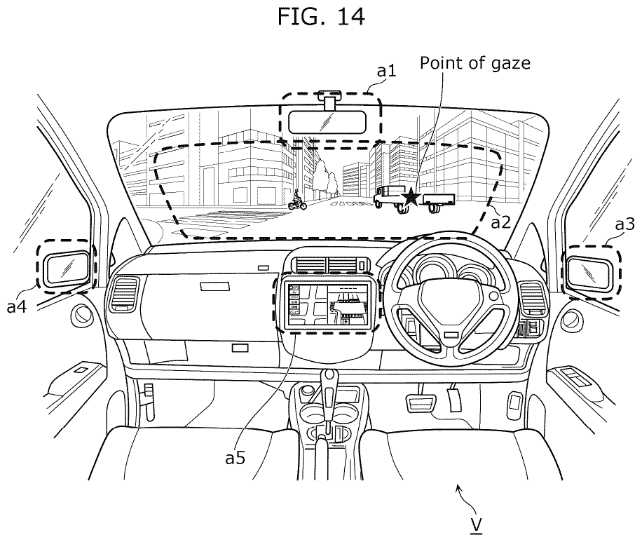

FIG. 14 is a diagram for describing the detection of visual observation of a vicinity object by vicinity visual observation detector 112.

As illustrated in, for example, FIG. 14, vicinity visual observation detector 112 detects the visual observation of a vicinity object by the driver, based on the detection result of a cognitive action, and the detection result of the vicinity object. Specifically, when the driver's point of gaze overlaps with a truck, which is a vicinity object, vicinity visual observation detector 112 detects the driver's visual observation of the truck.

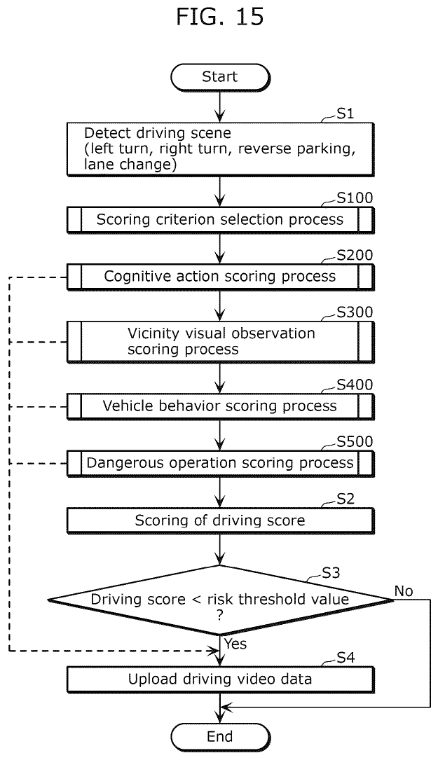

FIG. 15 is a flowchart illustrating an example of the overall process operation of driving assistance system 100a in the present embodiment.

Driving assistance system 100a in the present embodiment performs not only the process of each step included in the flowchart in FIG. 8 in Embodiment 1, but also a process in step S300 and a process in S500.

In other words, risk determiner 105 performs a vicinity visual observation scoring process based on the driving scene detected by driving scene detector 101, and the detection result of the visual observation of a vicinity object by vicinity visual observation detector 112 (step S300). This vicinity visual observation scoring process is a process for scoring the driving action score for the visual observation of the vicinity object in the detection scene, based on the scoring criterion selected in step S100.

Next, risk determiner 105 performs a dangerous operation scoring process based on the driving scene detected by driving scene detector 101, and the detection result of a dangerous operation by dangerous operation detector 111 (step S500). This dangerous operation scoring process is a process for scoring the driving action score for the dangerous operation in the detection scene, based on the scoring criterion selected in step S100.

Note that driving assistance system 100a may perform the process in step S4 by respective processes in steps S200, S300, S400, and S500. In addition, respective processes in steps S200, S300, S400, and S500 may be performed in any order. Further, the vicinity visual observation scoring process in step S300 and the dangerous operation scoring process in step S500 may be omitted, according to the driving scene detected by driving scene detector 101 and the detection result of the vicinity object by vicinity detector 104.

Additionally, in the present embodiment, risk determiner 105 determines the degree of risk of driving of vehicle V by the driver, based on the process results in steps S200, S300, S400, and S500. That is, risk determiner 105 determines the degree of risk by performing the scoring of the driving of vehicle V by the driver (step S2). Accordingly, the driving score is scored. Specifically, risk determiner 105 performs the scoring of the driving score by performing weighted addition on the driving action score that is scored in each of steps S200, S300, S400, and S500.

After the process in step S2, driving assistance system 100a performs the processes in steps S3 and S4 as in Embodiment 1.

Hereinafter, specific processes of driving assistance system 100a in the present embodiment will be described with reference to Example 1 to Example 6.

### Example 1 (Driving Scene: Right Turn, Vicinity Movable Object: None)

Example 1 is an example of specific processes of driving assistance system 100a in a case where a driving scene is a right turn at an intersection, and there is no oncoming car as a vicinity movable object.

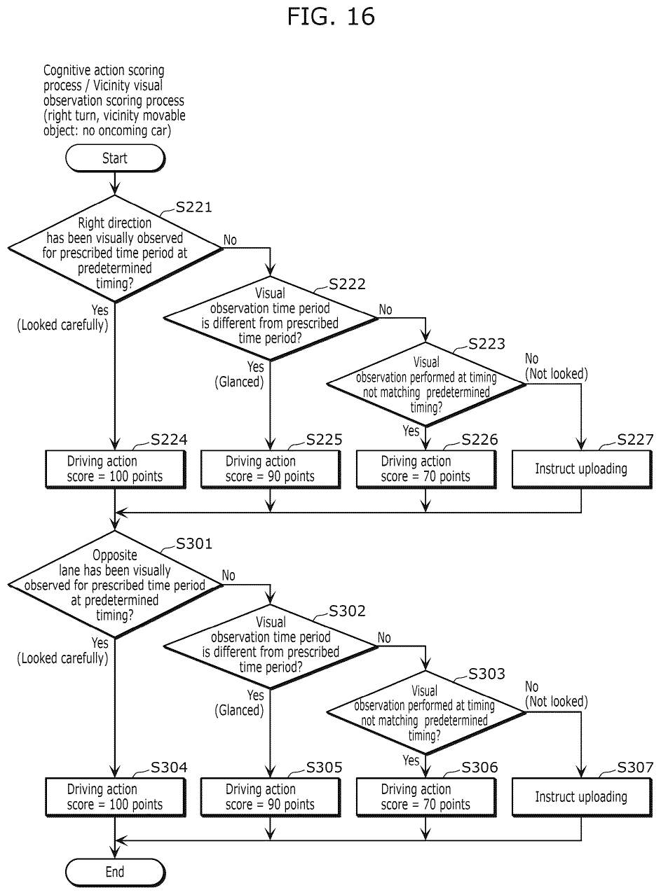

FIG. 16 is a flowchart illustrating a detailed example of the cognitive action scoring process and the vicinity visual observation scoring process. Note that FIG. 16 illustrates detailed processes in steps S200 and S300 in FIG. 15 in a case where a right turn is detected as a driving scene in step S1 in FIG. 15, and the first scoring criterion is adopted in step S100 in FIG. 15 (specifically, step S103 in FIG. 9). That is, FIG. 16 illustrates a detailed example of the cognitive action scoring process and the vicinity visual observation scoring process in the case where a right turn is performed when there is no oncoming car as a vicinity movable object.

### <Checking Right Direction>

First, risk determiner 105 determines whether or not the driver has visually observed the right direction of vehicle V for a prescribed time period at a predetermined timing, based on the detection result of a cognitive action by cognitive action detector 102 (step S221). The predetermined timing may be the same as or different from the predetermined timing at the time of the left turn in Embodiment 1. In addition, the prescribed time period may be the same as or different from the prescribed time period in Embodiment 1. For example, the prescribed time period may be a time period within a range from predefined time tb1 to predefined time tb2 (tb2>tb1). Here, when risk determiner 105 determines that the driver has visually observed the right direction of vehicle V for the prescribed time period at the predetermined timing (Yes in step S221), risk determiner 105 determines the driving action score for the cognitive action of the right direction to be 100 points (step S224).

On the other hand, when risk determiner 105 determines that the driver has not visually observed the right direction of vehicle V for the prescribed time period at the predetermined timing (No in step S221), risk determiner 105 determines whether or not the driver has visually observed the right direction for a time period that is different from the prescribed time period at the predetermined timing (step S222). Here, when risk determiner 105 determines that the driver has visually observed the right direction for the time period that is different from the prescribed time period at the predetermined timing (Yes in step S222), risk determiner 105 determines the driving action score for the cognitive action of the right direction to be 90 points (step S225). For example, when the driver has glanced at the right direction at the predetermined timing, 90 points is determined.

On the other hand, when risk determiner 105 determines that the driver has not visually observed the right direction for the time period that is different from the prescribed time period at the predetermined timing (No in step S222), risk determiner 105 determines whether or not visual observation of the right direction has been performed at a timing that does not match the predetermined timing (step S223). Here, when risk determiner 105 determines that the visual observation of the right direction has been performed at the timing that does not match the predetermined timing (Yes in step S223), risk determiner 105 determines the driving action score for the cognitive action of the right direction to be 70 points (step S226). On the other hand, when risk determiner 105 determines that the visual observation of the right direction has not been performed at the timing that does not match the predetermined timing (No in step S223), risk determiner 105 instructs uploader 107 to upload driving video data (step S227). For example, when the driver has not looked at the right direction, the uploading is instructed. As a result, the process in step S4 in FIG. 15 is performed.

### <Checking Opposite Lane>

Furthermore, risk determiner 105 determines whether or not the driver has visually observed the opposite lane as a vicinity object for a prescribed time period at a predetermined timing, based on the detection result of the visual observation by vicinity visual observation detector 112 (step S301). Note that the predetermined timing is, for example, a timing when vehicle V is located in front of an intersection before entering the opposite lane side. In addition, the prescribed time period may be the same as or different from the prescribed time period in Embodiment 1. For example, the prescribed time period may be a time period within a range from predefined time tc1 to predefined time tc2 (tc2>tc1). In addition, when there are a plurality of opposite lanes, it may be determined whether or not the driver has visually observed those plurality of opposite lanes. Here, when risk determiner 105 determines that the driver has visually observed the opposite lane for the prescribed time period at the predetermined timing (Yes in step S301), risk determiner 105 determines the driving action score for the visual observation of the opposite lane to be 100 points (step S304).

On the other hand, when risk determiner 105 determines that the driver has not visually observed the opposite lane for the prescribed time period at the predetermined timing (No in step S301), risk determiner 105 determines whether or not the driver has visually observed the opposite lane for a time period that is different from the prescribed time period at the predetermined timing (step S302). Here, when risk determiner 105 determines that the driver has visually observed the opposite lane for the time period that is different from the prescribed time period at the predetermined timing (Yes in step S302), risk determiner 105 determines the driving action score for the visual observation of the opposite lane to be 90 points (step S305). For example, when the driver has glanced at the opposite lane at the predetermined timing, 90 points is determined.

On the other hand, when risk determiner 105 determines that the driver has not visually observed the opposite lane for the time period that is different from the prescribed time period at the predetermined timing (No in step S302), risk determiner 105 determines whether or not the visual observation of the opposite lane has been performed at a timing that does not match the predetermined timing (step S303). Here, when risk determiner 105 determines that the visual observation of the opposite lane has been performed at the timing that does not match the predetermined timing (Yes in step S303), risk determiner 105 determines the driving action score for the visual observation of the opposite lane to be 70 points (step S306). On the other hand, when risk determiner 105 determines that the visual observation of the opposite lane has not been performed at the timing that does not match the predetermined timing (No in step S303), risk determiner 105 instructs uploader 107 to upload driving video data (step S307). For example, when the driver has not looked at the opposite lane, the uploading is instructed. As a result, the process in step S4 in FIG. 15 is performed.

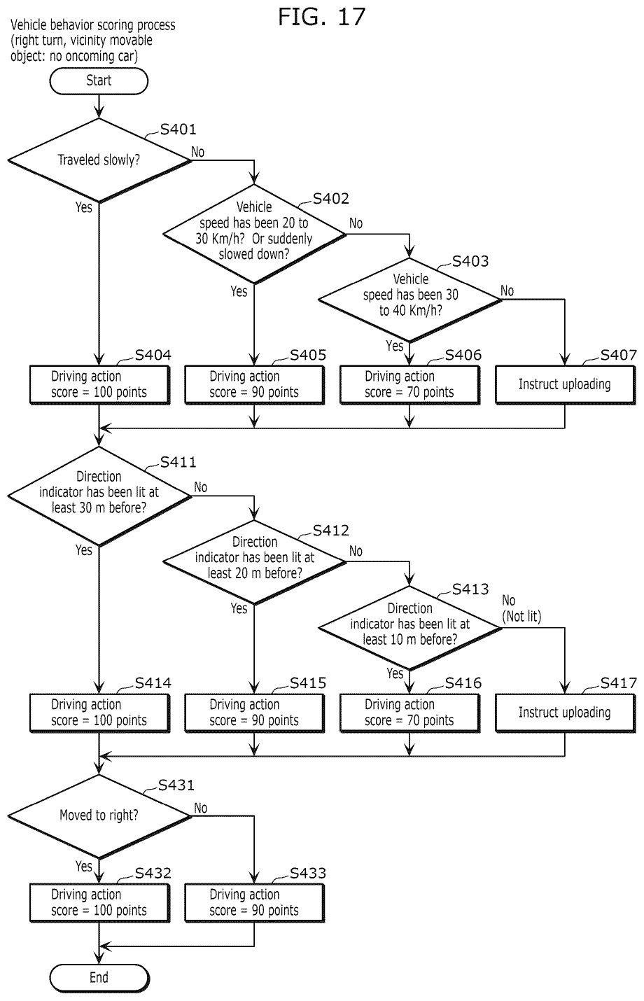

FIG. 17 is a flowchart illustrating a detailed example of the vehicle behavior scoring process. Note that FIG. 17 illustrates detailed processes in step S400 in FIG. 15 in the case where a right turn is detected as a driving scene in step S1 in FIG. 15, and the first scoring criterion is adopted in step S100 in FIG. 15 (specifically, step S103 in FIG. 9). That is, FIG. 17 illustrates a detailed example of the vehicle behavior scoring process in the case where the right turn is performed when there is no oncoming car as a vicinity movable object.

### <Slow Traveling and Direction Indication>

First, as in the example illustrated in FIG. 11, risk determiner 105 performs the processes in steps S401 to S407, and the processes in steps S411 to S417. Accordingly, the driving action score for the vehicle speed and the driving action score for the direction indication are determined.

### <Movement to Right Side>

Furthermore, risk determiner 105 determines whether or not vehicle V has moved to the right side before turning right, based on the detection result of the behavior of vehicle V by vehicle behavior detector 103 (step S431). Here, when risk determiner 105 determines that vehicle V has moved to the right side (Yes in step S431), risk determiner 105 determines the driving action score for the movement to the right side to be 100 points (step S432). On the other hand, when risk determiner 105 determines that vehicle V has not moved to the right side (No in step S431), risk determiner 105 determines the driving action score for the movement to the right side to be 90 points (step S433).

As a result, in step S2 in FIG. 15, risk determiner 105 calculates the driving score for the driving of vehicle V by the driver, by performing weighted addition on the driving action score for each of the cognitive action of the right direction, the visual observation of the opposing lane, the vehicle speed, the direction indication, and the movement to the right side. Note that, in Example 1, since there is no oncoming car as a vicinity movable object, the process in step S500 in FIG. 15 is omitted.

### Example 2 (Driving Scene: Right Turn, Vicinity Movable Object (Oncoming Car): Yes)

Example 2 is an example of specific processes of driving assistance system 100a in a case where a driving scene is a right turn at an intersection, and there is an oncoming car as a vicinity movable object.

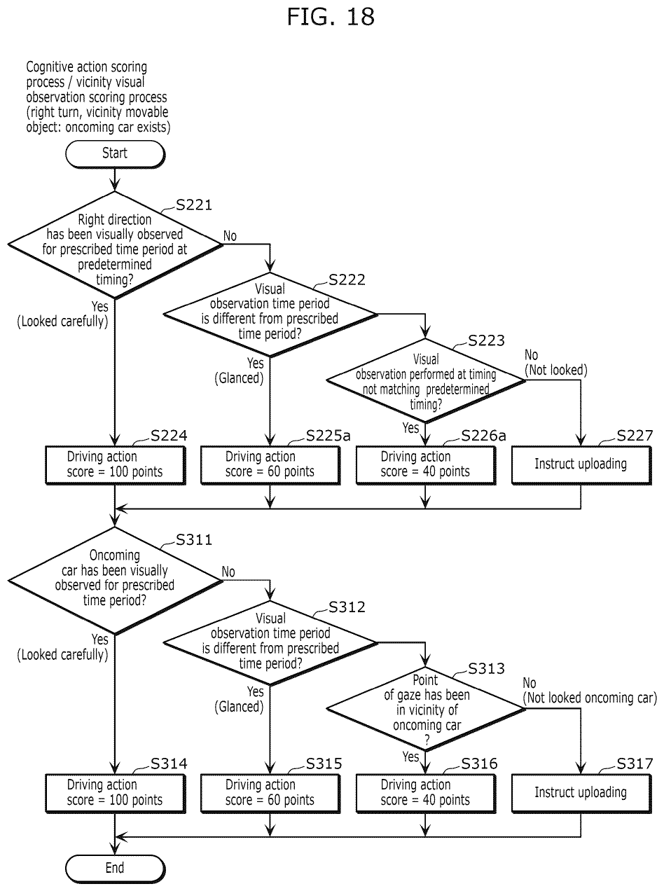

FIG. 18 is a flowchart illustrating a detailed example of the cognitive action scoring process and the vicinity visual observation scoring process. Note that FIG. 18 illustrates detailed processes in steps S200 and S300 in FIG. 15 in a case where a right turn is detected as a driving scene in step S1 in FIG. 15, and the second scoring criterion is adopted in step S100 in FIG. 15 (specifically, step S102 in FIG. 9). That is, FIG. 18 illustrates a detailed example of the cognitive action scoring process and the vicinity visual observation scoring process in the case where the right turn is performed when there is an oncoming car as a vicinity movable object.

### <Checking Right Direction>

First, as illustrated in FIG. 18, although risk determiner 105 performs processes similar to steps S221 to S227 in FIG. 16, risk determiner 105 performs processes in steps S225a and S226a, instead of steps S225 and S226.

In other words, in step S222, when risk determiner 105 determines that the driver has visually observed the right direction for the time period that is different from the prescribed time period at the predetermined timing (Yes in step S222), risk determiner 105 determines the driving action score for the cognitive action of the right direction to be 60 points (step S225a). For example, when the driver has glanced at the right direction at the predetermined timing, 60 points is determined. While 90 points is determined in Example 1 without an oncoming car (that is, the example of FIG. 16), 60 points, which is lower than 90 points, is determined in Example 2 with an oncoming car (that is, the example of FIG. 18). In this manner, the scoring is more severe in the second scoring criterion than in the first scoring criterion.

Similarly, in step S223, when risk determiner 105 determines that the visual observation of the right direction has been performed at a timing that does not match the predetermined timing (Yes in step S223), risk determiner 105 determines the driving action score for the cognitive action of the right direction to be 40 points (step S226a). While 70 points is determined in Example 1 without an oncoming car (that is, the example of FIG. 16), 40 points, which is lower than 70 points, is determined in Example 2 with an oncoming car (that is, the example of FIG. 18). In this manner, the scoring is more severe in the second scoring criterion than in the first scoring criterion.

### <Checking Oncoming Car>

Furthermore, risk determiner 105 determines whether or not the driver has visually observed the oncoming car for a prescribed time period, based on the detection result of the visual observation by vicinity visual observation detector 112 (step S311). The prescribed time period may be the same as or different from the prescribed time period in Embodiment 1. For example, the prescribed time period may be a time period within a range from predefined time td1 to predefined time td2 (td2>td1). In addition, when an oncoming car is traveling in each of a plurality of opposite lanes, whether or not the driver has visually observed those plurality of oncoming cars may be determined. Here, when risk determiner 105 determines that the driver has visually observed the oncoming car for the prescribed time period (Yes in step S311), risk determiner 105 determines the driving action score for the visual observation of the oncoming car to be 100 points (step S314).

On the other hand, when risk determiner 105 determines that the driver has not visually observed the oncoming car for the prescribed time period at the predetermined timing (No in step S311), risk determiner 105 determines whether or not the driver has visually observed the oncoming car for a time period that is different from the prescribed time period (step S312). Here, when risk determiner 105 determines that the driver has visually observed the oncoming car for the time period that is different from the prescribed time period (Yes in step S312), risk determiner 105 determines the driving action score for the visual observation of the oncoming car to be 60 points (step S315). For example, when the driver has glanced at the oncoming car, 60 points is determined.

On the other hand, when risk determiner 105 determines that the driver has not visually observed the oncoming car for the time period that is different from the prescribed time period (No in step S312), risk determiner 105 determines whether or not the point of gaze has been in the vicinity of the oncoming car (step S313). Here, when risk determiner 105 determines that the point of gaze has been in the vicinity of the oncoming car (Yes in step S313), risk determiner 105 determines the driving action score for the visual observation of the oncoming car to be 40 points (step S316). On the other hand, when risk determiner 105 determines that the point of gaze has not been in the vicinity of the oncoming car (No in step S313), risk determiner 105 instructs uploader 107 to upload driving video data (step S317). For example, when the driver has not looked at the oncoming car at all, the uploading is instructed. As a result, the process in step S4 in FIG. 15 is performed.

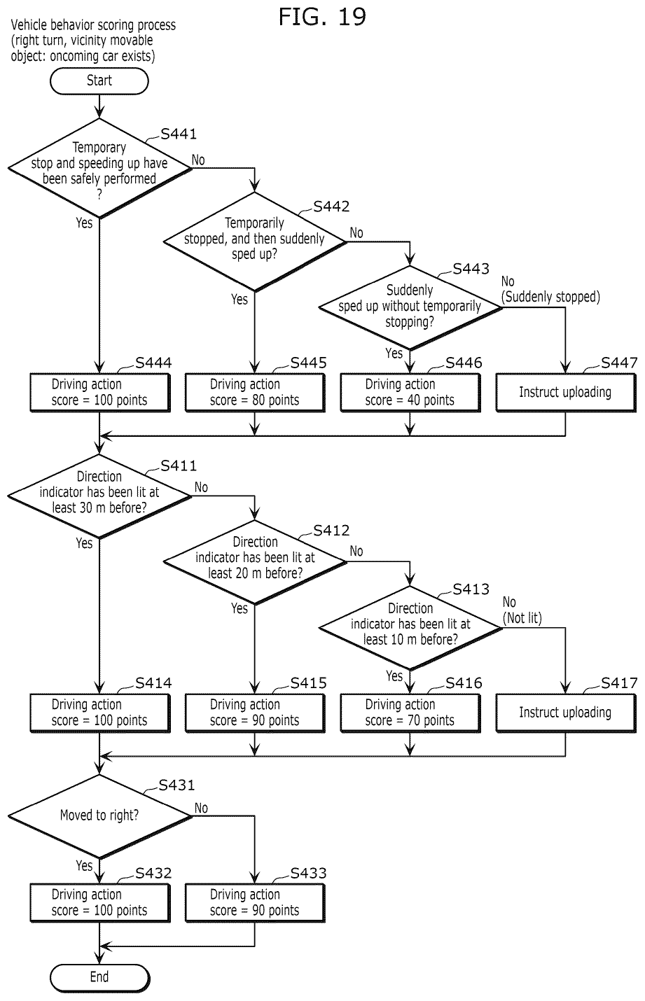

FIG. 19 is a flowchart illustrating a detailed example of the vehicle behavior scoring process. Note that FIG. 19 illustrates detailed processes in step S400 in FIG. 15 in the case where a right turn is detected as a driving scene in step S1 in FIG. 15, and the second scoring criterion is adopted in step S100 in FIG. 15 (specifically, step S102 in FIG. 9). That is, FIG. 19 illustrates a detailed example of the vehicle behavior scoring process in the case where the right turn is performed when there is an oncoming car as a vicinity movable object.

### <Temporary Stop/Speeding Up>

First, risk determiner 105 determines whether or not vehicle V has safely performed temporary stop and predetermined speeding up, based on the detection result of the behavior of vehicle V by vehicle behavior detector 103 (step S441). For example, when vehicle V has temporarily stopped at an intersection without suddenly slowing down, risk determiner 105 determines that vehicle V has safely performed temporary stop. In addition, the predetermined speeding up is speeding up performed at a predefined timing and in an allowable range of acceleration. For example, when vehicle V, which has been temporarily stopped, speeds up in the allowable range of acceleration at a timing sufficiently before an oncoming car travels straight to enter an intersection, or a timing after the time point at which the oncoming car travels straight and passes the intersection, risk determiner 105 determines that vehicle V has safely performed the predetermined speeding up. The timing sufficiently before the oncoming car travels straight to enter the intersection may be a timing sc1 seconds, which is predefined, after the time point at which the oncoming car travels straight to enter the intersection, and sc1 may be, for example, a numerical value of one or more. Here, when risk determiner 105 determines that vehicle V has safely performed temporary stop and the predetermined speeding up (Yes in step S441), risk determiner 105 determines the driving action score for the vehicle speed to be 100 points (step S444).

On the other hand, when risk determiner 105 determines that vehicle V has not safely performed temporary stop and the predetermined speeding up (No in step S441), risk determiner 105 determines whether or not vehicle V has suddenly sped up (step S442). For example, when the acceleration of vehicle V is greater than the above-described allowable range, risk determiner 105 determines that vehicle V has suddenly sped up. Here, when risk determiner 105 determines that vehicle V has suddenly sped up (Yes in step S442), risk determiner 105 determines the driving action score for the vehicle speed to be 80 points (step S445).

On the other hand, when risk determiner 105 determines that vehicle V has not suddenly sped up (No in step S442), risk determiner 105 determines whether or not vehicle V has suddenly sped up without temporarily stopping (step S443). Here, when risk determiner 105 determines that vehicle V has suddenly sped up without temporarily stopping (Yes in step S443), risk determiner 105 determines the driving action score for the vehicle speed to be 40 points (step S446). On the other hand, when risk determiner 105 determines that vehicle V has not suddenly sped up without temporarily stopping (No in step S443), risk determiner 105 determines that vehicle V has suddenly stopped, and instructs uploader 107 to upload driving video data (step S447). As a result, the process in step S4 in FIG. 15 is performed.

### <Direction Indication>

Furthermore, risk determiner 105 performs the processes in steps S411 to S417 as in the example illustrated in FIG. 11. Accordingly, the driving action score for direction indication is determined.

### <Movement to Right Side>

Furthermore, risk determiner 105 performs the processes in steps S431 to S433 as in the example illustrated in FIG. 17. Accordingly, the driving action score for the movement to the right side is determined.

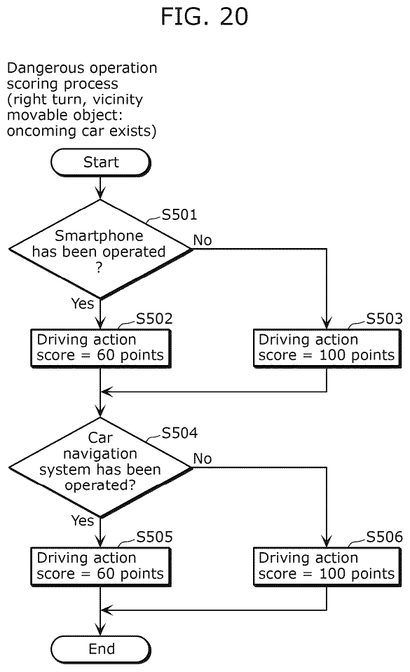

FIG. 20 is a flowchart illustrating a detailed example of the dangerous operation scoring process. Note that FIG. 20 illustrates detailed processes in step S500 in FIG. 15 in the case where a right turn is detected as a driving scene in step S1 in FIG. 15, and the second scoring criterion is adopted in step S100 in FIG. 15 (specifically, step S102 in FIG. 9). That is, FIG. 20 illustrates a detailed example of the dangerous operation scoring process in the case where the right turn is performed when there is an oncoming car as a vicinity movable object.

### <Smartphone>

First, risk determiner 105 determines whether or not the driver operated the smartphone, based on the detection result of a dangerous operation by dangerous operation detector 111 (step S501). Here, when risk determiner 105 determines that the driver has operated the smartphone (Yes in step S501), risk determiner 105 determines the driving action score for the smartphone operation to be 60 points (step S502). On the other hand, when risk determiner 105 determines that the driver has not operated the smartphone (No in step S501), risk determiner 105 determines the driving action score for the smartphone operation to be 100 points (step S503).

### <Car Navigation System>

Furthermore, risk determiner 105 determines whether or not the driver has operated the car navigation system, based on the detection result of the dangerous operation by dangerous operation detector 111 (step S504). Here, when risk determiner 105 determines that the driver has operated the car navigation system (Yes in step S504), risk determiner 105 determines the driving action score for the car navigation system operation to be 60 points (step S505). On the other hand, when risk determiner 105 determines that the driver has not operated the car navigation system (No in step S504), risk determiner 105 determines the driving action score for the car navigation system operation to be 100 points (step S506).

As a result, in step S2 in FIG. 15, risk determiner 105 calculates the driving score for the driving of vehicle V by the driver, by performing weighted addition on the driving action score for each of the cognitive action of the right direction, the visual observation of the oncoming car, the vehicle speed, the direction indication, the movement to the right side, the smartphone operation, and the car navigation system operation.

### Example 3 (Driving Scene: Reverse Parking, Vicinity Movable Object: None)

Example 3 is an example of specific processes of driving assistance system 100a in a case where a driving scene is reverse parking in a parking lot, and there is no vicinity movable object. Note that a vicinity movable object is, for example, a person in the parking lot, another vehicle, or the like.

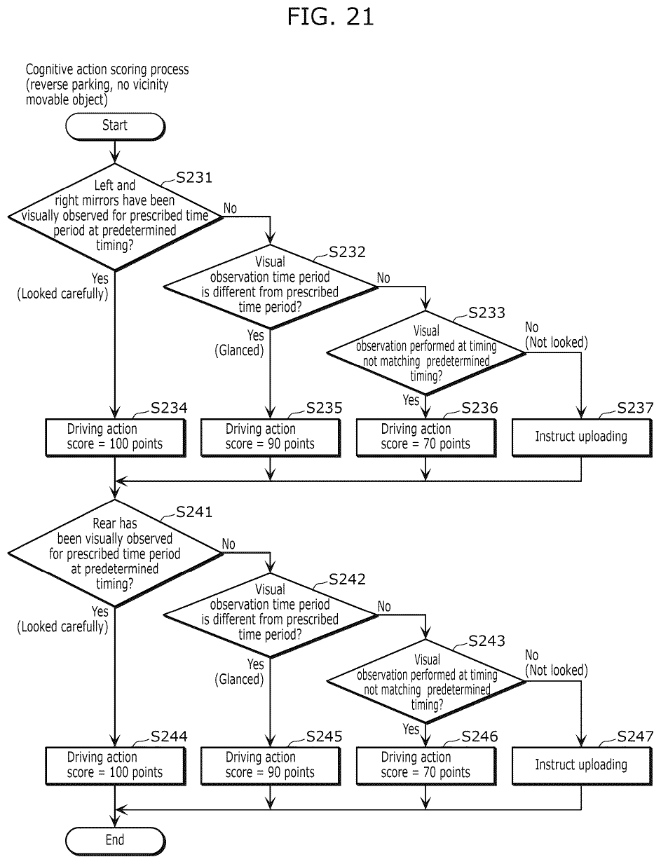

FIG. 21 is a flowchart illustrating a detailed example of the cognitive action scoring process. Note that FIG. 21 illustrates detailed processes in step S200 in FIG. 15 in a case where reverse parking is detected as a driving scene in step S1 in FIG. 15, and the first scoring criterion is adopted in step S100 in FIG. 15 (specifically, step S103 in FIG. 9). That is, FIG. 21 illustrates a detailed example of the cognitive action scoring process in the case of where reverse parking is performed when there is no vicinity movable object.

### <Checking Right and Left Mirrors>

First, risk determiner 105 determines whether or not the driver has visually observed the left mirror and the right mirror of vehicle V for a prescribed time period at a predetermined timing, based on the detection result of a cognitive action by cognitive action detector 102 (step S231). The predetermined timing may be a timing when vehicle V is backing up, or may be a timing sc2 seconds or less before the backing up is started. sc2 is any numerical value larger than 0. In addition, the prescribed time period may be the same as or different from the prescribed time period in Embodiment 1. For example, the prescribed time period may be a time period within a range from predefined time te1 to predefined time te2 (te2>te1). Here, when risk determiner 105 determines that the driver has visually observed the left mirror and the right mirror of vehicle V for the prescribed time period at the predetermined timing (Yes in step S231), risk determiner 105 determines the driving action score for the cognitive action of the left mirror and the right mirror to be 100 points (step S234).

On the other hand, when risk determiner 105 determines that the driver has not visually observed the left mirror and the right mirror of vehicle V for the prescribed time period at the predetermined timing (No in step S231), risk determiner 105 determines whether or not the driver has visually observed the left mirror and the right mirror for a time period that is different from the prescribed time period at the predetermined timing (step S232). Here, when risk determiner 105 determines that the driver has visually observed the left mirror and the right mirror for the time period that is different from the prescribed time period at the predetermined timing (Yes in step S232), risk determiner 105 determines the driving action score for the cognitive action of the left mirror and the right mirror to be 90 points (step S235). For example, when the driver has glanced at the left mirror and the right mirror at the predetermined timing, 90 points is determined.

On the other hand, when risk determiner 105 determines that the driver has not visually observed the left mirror and the right mirror for the time period that is different from the prescribed time period at the predetermined timing (No in step S232), risk determiner 105 determines whether or not the visual observation of the left mirror and the right mirror has been performed at a timing that does not match the predetermined timing (step S233). Here, when risk determiner 105 determines that the visual observation of the left mirror and the right mirror has been performed at the timing that does not match the predetermined timing (Yes in step S233), risk determiner 105 determines the driving action score for the cognitive action of the left mirror and the right mirror to be 70 points (step S236). On the other hand, when risk determiner 105 determines that the visual observation of the left mirror and the right mirror has not been performed at the timing that does not match the predetermined timing (No in step S233), risk determiner 105 instructs uploader 107 to upload driving video data (step S237). For example, when the driver has not looked at the left mirror and the right mirror, the uploading is instructed. As a result, the process in step S4 in FIG. 15 is performed.

### <Checking Rear>

Furthermore, risk determiner 105 determines whether or not the driver has visually observed the rear of vehicle V for a prescribed time period at a predetermined timing, based on the detection result of a cognitive action by cognitive action detector 102 (step S241). The predetermined timing and the prescribed time period may be the same as or different from the predetermined timing and the prescribed time period that are used in step S231. Here, when risk determiner 105 determines that the driver has visually observed the rear of vehicle V for the prescribed time period at the predetermined timing (Yes in step S241), risk determiner 105 determines the driving action score for the cognitive action of the rear to be 100 points (step S244).

On the other hand, when risk determiner 105 determines that the driver has not visually observed the rear of vehicle V for the prescribed time period at the predetermined timing (No in step S241), risk determiner 105 determines whether or not the driver has visually observed the rear for a time period that is different from the prescribed time period at the predetermined timing (step S242). Here, when risk determiner 105 determines that the driver has visually observed the rear for the time period that is different from the prescribed time period at the predetermined timing (Yes in step S242), risk determiner 105 determines the driving action score for the cognitive action of the rear to be 90 points (step S245). For example, when the driver has glanced at the rear at the predetermined timing, 90 points is determined.

On the other hand, when risk determiner 105 determines that the driver has not visually observed the rear for the time period that is different from the prescribed time period at the predetermined timing (No in step S242), risk determiner 105 determines whether or not the visual observation of the rear has been performed at the timing that does not match the predetermined timing (step S243). Here, when risk determiner 105 determines that the visual observation of the rear has been performed at the timing that does not match the predetermined timing (Yes in step S243), risk determiner 105 determines the driving action score for the cognitive action of the rear to be 70 points (step S246). On the other hand, when risk determiner 105 determines that the visual observation of the rear has not been performed at the timing that does not match the predetermined timing (No in step S243), risk determiner 105 instructs uploader 107 to upload driving video data (step S247). For example, when the driver has not looked at the rear, the uploading is instructed. As a result, the process in step S4 in FIG. 15 is performed.

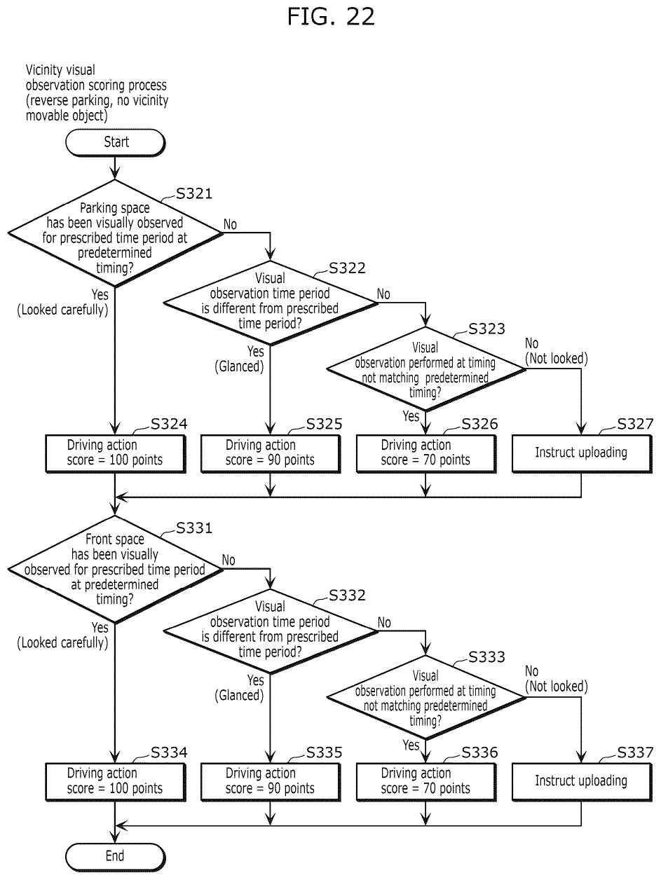

FIG. 22 is a flowchart illustrating a detailed example of the vicinity visual observation scoring process. Note that FIG. 22 illustrates detailed processes in step S300 in FIG. 15 in the case where reverse parking is detected as a driving scene in step S1 in FIG. 15, and the first scoring criterion is adopted in step S100 in FIG. 15 (specifically, step S103 in FIG. 9). That is, FIG. 22 illustrates a detailed example of the vicinity visual observation scoring process in the case where reverse parking is performed when there is no vicinity movable object.

### <Checking Parking Space>

First, risk determiner 105 determines whether or not the driver has visually observed a parking space for a prescribed time period at a predetermined timing, based on the detection result of visual observation by vicinity visual observation detector 112 (step S321). The predetermined timing may be similar to or different from the timing in the example in FIG. 21. In addition, the prescribed time period may be the same as or different from the prescribed time period in Embodiment 1. For example, the prescribed time period may be a time period within a range from predefined time tf1 to predefined time tf2 (tf2>tf1). In addition, the parking space is, for example, a space that is surrounded by white lines in the parking lot, and in which no vehicle is parked. Here, when risk determiner 105 determines that the driver has visually observed the parking space for the prescribed time period at the predetermined timing (Yes in step S321), risk determiner 105 determines the driving action score for the visual observation of the parking space to be 100 points (step S324).

On the other hand, when risk determiner 105 determines that the driver has not visually observed the parking space for the prescribed time period at the predetermined timing (No in step S321), risk determiner 105 determines whether or not the driver has visually observed the parking space for a time period that is different from the prescribed time period at the predetermined timing (step S322). Here, when risk determiner 105 determines that the driver has visually observed the parking space for the time period that is different from the prescribed time period at the predetermined timing (Yes in step S322), risk determiner 105 determines the driving action score for the visual observation of the parking space to be 90 points (step S325). For example, when the driver has glanced at the parking space at the predetermined timing, 90 points is determined.

On the other hand, when risk determiner 105 determines that the driver has not visually observed the parking space for the time period that is different from the prescribed time period at the predetermined timing (No in step S322), risk determiner 105 determines whether or not the visual observation of the parking space has been performed at a timing that does not match the predetermined timing (step S323). Here, when risk determiner 105 determines that the visual observation of the parking space has been performed at the timing that does not match the predetermined timing (Yes in step S323), risk determiner 105 determines the driving action score for the visual observation of the parking space to be 70 points (step S326). On the other hand, when risk determiner 105 determines that the visual observation of the parking space has not been performed at the timing that does not match the predetermined timing (No in step S323), risk determiner 105 instructs uploader 107 to upload driving video data (step S327). For example, when the driver has not looked at the parking space, the uploading is instructed. As a result, the process in step S4 in FIG. 15 is

### <Checking Front>

Furthermore, risk determiner 105 determines whether or not the driver has visually observed a front space for a prescribed time period at a predetermined timing, based on the detection result of the visual observation by vicinity visual observation detector 112 (step S331). The predetermined timing and the prescribed time period may be the same as or different from the predetermined timing and the prescribed time period that are used at step S321. In addition, the front space is a space around a front end portion of vehicle V, or around front left and right end portions of vehicle V. Here, when risk determiner 105 determines that the driver has visually observed the front space for the prescribed time period at the predetermined timing (Yes in step S331), risk determiner 105 determines the driving action score for the visual observation of the front space to be 100 points (step S334).

On the other hand, when risk determiner 105 determines that the driver has not visually observed the front space for the prescribed time period at the predetermined timing (No in step S331), risk determiner 105 determines whether or not the driver has visually observed the front space for a time period that is different from the prescribed time period at the predetermined timing (step S332). Here, when risk determiner 105 determines that the driver has visually observed the front space for the time period that is different from the prescribed time period at the predetermined timing (Yes in step S332), risk determiner 105 determines the driving action score for the visual observation of the front space to be 90 points (step S335). For example, when the driver has glanced at the front space at the predetermined timing, 90 points is determined.

On the other hand, when risk determiner 105 determines that the driver has not visually observed the front space for the time period that is different from the prescribed time period at the predetermined timing (No in step S332), risk determiner 105 determines whether or not the visual observation of the front space has been performed at a timing that does not match the predetermined timing (step S333). Here, when risk determiner 105 determines that visual observation of the front space has been performed at the timing that does not match the predetermined timing (Yes in step S333), risk determiner 105 determines the driving action score for the visual observation of the front space to be 70 points (step S336). On the other hand, when risk determiner 105 determines that the visual observation of the front space has not been performed at the timing that does not match the predetermined timing (No in step S333), risk determiner 105 instructs uploader 107 to upload driving video data (step S337). For example, when the driver has not looked at the front space, the uploading is instructed. As a result, the process in step S4 in FIG. 15 is performed.

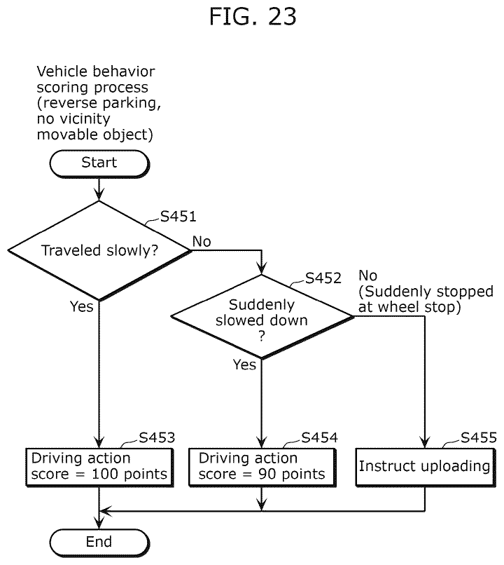

FIG. 23 is a flowchart illustrating a detailed example of the vehicle behavior scoring process. Note that FIG. 23 illustrates detailed processes in step S400 in FIG. 15 in the case where reverse parking is detected as a driving scene in step S1 in FIG. 15, and the first scoring criterion is adopted in step S100 in FIG. 15 (specifically, step S103 in FIG. 9). That is, FIG. 22 illustrates a detailed example of the vehicle behavior scoring process in the case of where reverse parking is performed when there is no vicinity movable object.

### <Vehicle Speed>

First, risk determiner 105 determines whether or not vehicle V has traveled slowly at acceleration within a first acceleration range and stopped, based on the detection result of a behavior of vehicle V by vehicle behavior detector 103 (step S451). The first acceleration range is a predefined negative acceleration range. Here, when risk determiner 105 determines that vehicle V has traveled slowly and stopped (Yes in step S451), risk determiner 105 determines the driving action score for the vehicle speed to be 100 points (step S453).

On the other hand, when risk determiner 105 determines that vehicle V has not traveled slowly and stopped (No in step S451), risk determiner 105 determines whether or not vehicle V has suddenly slowed down (step S452). For example, when vehicle V has backed up and stopped at acceleration within a second acceleration range that is smaller than the first acceleration range, risk determiner 105 determines that vehicle V has suddenly slowed down. Here, when risk determiner 105 determines that vehicle V has suddenly slowed down (Yes in step S452), risk determiner 105 determines the driving action score for the vehicle speed to be 90 points (step S454).

On the other hand, when risk determiner 105 determines that vehicle V has not suddenly slowed down (No in step S452), risk determiner 105 determines that vehicle V has traveled at acceleration smaller than the second acceleration range. That is, risk determiner 105 determines that vehicle V has suddenly stopped at a wheel stop. As a result, risk determiner 105 instructs uploader 107 to upload driving video data (step S455). As a result, the process in step S4 in FIG. 15 is performed.

Then, in step S2 in FIG. 15, risk determiner 105 calculates the driving score for the driving of vehicle V by the driver, by performing weighted addition on the driving action score for each of the cognitive action of the left mirror and the right mirror, the cognitive action of the rear, the visual observation of the parking space, the visual observation of the front space, and the vehicle speed.

### Example 4 (Driving Scene: Reverse Parking, Vicinity Movable Object (Oncoming Car): Yes)

Example 4 is an example of specific processes of driving assistance system 100a in a case where a driving scene is reverse parking in a parking lot, and there is a vicinity movable object.

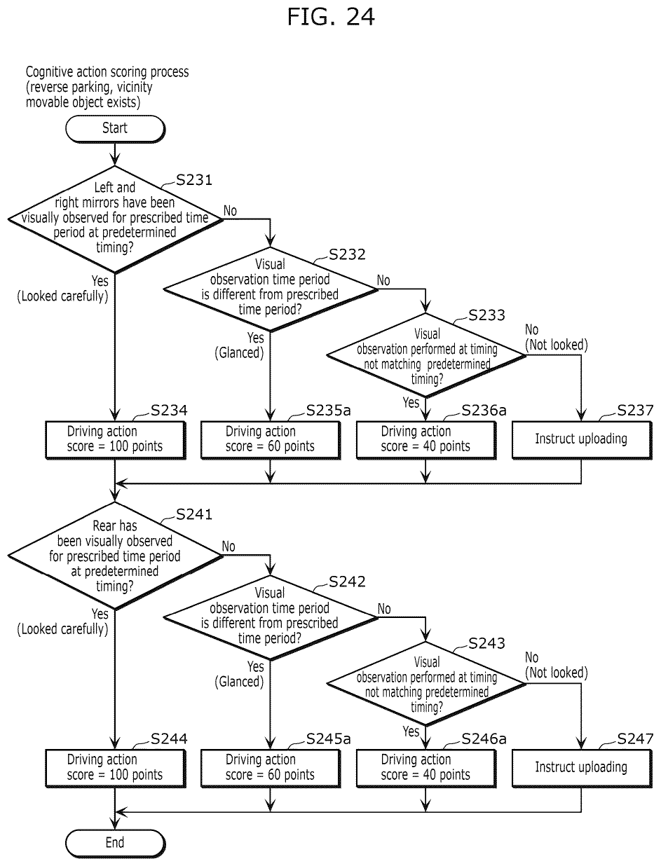

FIG. 24 is a flowchart illustrating a detailed example of the cognitive action scoring process. Note that FIG. 24 illustrates detailed processes in step S200 in FIG. 15 in a case where reverse parking is detected as a driving scene in step S1 in FIG. 15, and the second scoring criterion is adopted in step S100 in FIG. 15 (specifically, step S102 in FIG. 9). That is, FIG. 24 illustrates a detailed example of the cognitive action scoring process in the case where reverse parking is performed when there is a vicinity movable object.

### <Checking Right and Left Mirrors>

First, as illustrated in FIG. 24, although risk determiner 105 performs processes similar to steps S231 to S237 in FIG. 21, risk determiner 105 performs processes in steps S235a and S236a, instead of steps S235 and S236.

In other words, in step S232, when risk determiner 105 determines that the driver has visually observed the left mirror and the right mirror for the time period that is different from the prescribed time period at the predetermined timing (Yes in step S232), risk determiner 105 determines the driving action score for the cognitive action of the left mirror and the right mirror to be 60 points (step S235a). For example, when the driver has glanced at the left mirror and the right mirror at the predetermined timing, 60 points is determined. While 90 points is determined in Example 3 (that is, the example in FIG. 21) without a vicinity movable object, 60 points, which is lower than 90 points, is determined in Example 4 (that is, the example in FIG. 24) with a vicinity movable object. In this manner, the scoring is more severe in the second scoring criterion than in the first scoring criterion.

Similarly, in step S233, when risk determiner 105 determines that the visual observation of the left mirror and the right mirror has been performed at a timing that does not match the predetermined timing (Yes in step S233), risk determiner 105 determines the driving action score for the cognitive action of the left mirror and the right mirror to be 40 points (step S236a). While 70 points is determined in Example 3 (that is, the example in FIG. 21) without a vicinity movable object, 40 points, which is lower than 70 points, is determined in Example 4 (that is, the example in FIG. 24) with a vicinity movable object. In this manner, the scoring is more severe in the second scoring criterion than in the first scoring criterion.

### <Checking Left Direction>

Next, although risk determiner 105 performs processes similar to steps S241 to S247 in FIG. 21, risk determiner 105 performs processes in steps S245a and S246a, instead of steps S245 and S246.

In other words, in step S242, when risk determiner 105 determines that the driver has visually observed the rear for a time period that is different from the prescribed time period at the predetermined timing (Yes in step S242), risk determiner 105 determines the driving action score for the cognitive action of the rear to be 60 points (step S245a). For example, when the driver has glanced at the left direction at the predetermined timing, 60 points is determined. While 90 points is determined in Example 3 (that is, the example in FIG. 21) without a vicinity movable object, 60 points, which is lower than 90 points, is determined in Example 4 (that is, the example in FIG. 24) with a vicinity movable object. In this manner, the scoring is more severe in the second scoring criterion than in the first scoring criterion.

Similarly, in step S243, when risk determiner 105 determines that the visual observation of the rear has been performed at the timing that does not match the predetermined timing (Yes in step S243), risk determiner 105 determines the driving action score for the cognitive action of the rear to be 40 points (step S246a). While 70 points is determined in Example 3 (that is, the example in FIG. 21) without a vicinity movable object, 40 points, which is lower than 70 points, is determined in Example 4 (that is, the example in FIG. 24) with a vicinity movable object. In this manner, the scoring is more severe in the second scoring criterion than in the first scoring criterion.

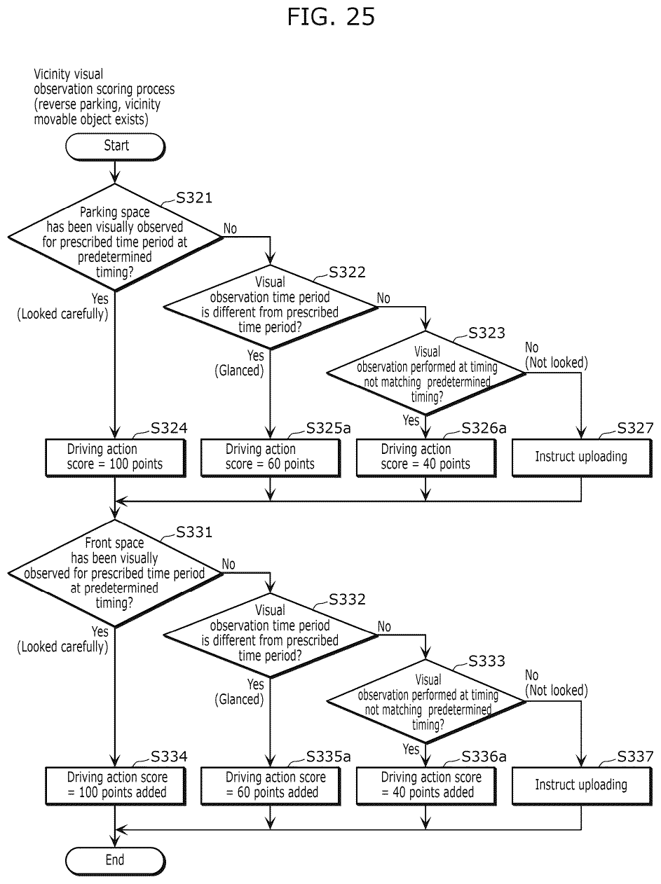

FIG. 25 is a flowchart illustrating a detailed example of the vicinity visual observation scoring process. Note that FIG. 25 illustrates detailed processes in step S300 in FIG. 15 in the case where reverse parking is detected as a driving scene in step S1 in FIG. 15, and the second scoring criterion is adopted in step S100 in FIG. 15 (specifically, step S102 in FIG. 9). That is, FIG. 25 illustrates a detailed example of the vicinity visual observation scoring process in the case where reverse parking is performed when there is a vicinity movable object.

### <Checking Parking Space>

First, as illustrated in FIG. 25, although risk determiner 105 performs processes similar to steps S321 to S327 in FIG. 22, risk determiner 105 performs processes in steps S325a and S326a, instead of steps S325 and S326.

In other words, in step S322, when risk determiner 105 determines that the driver has visually observed the parking space for the time period that is different from the prescribed time period at the predetermined timing (Yes in step S322), risk determiner 105 determines the driving action score for the visual observation of the parking space to be 60 points (step S325a). For example, when the driver has glanced at the parking space at the predetermined timing, 60 points is determined. While 90 points is determined in Example 3 (that is, the example in FIG. 22) without a vicinity movable object, 60 points, which is lower than 90 points, is determined in Example 4 (that is, the example in FIG. 25) with a vicinity movable object. In this manner, the scoring is more severe in the second scoring criterion than in the first scoring criterion.

Similarly, in step S323, when risk determiner 105 determines that the visual observation of the parking space has been performed at the timing that does not match the predetermined timing (Yes in step S323), risk determiner 105 determines the driving action score for the visual observation of the parking space to be 40 points (step S326a). While 70 points is determined in Example 3 (that is, the example in FIG. 22) without a vicinity movable object, 40 points, which is lower than 70 points, is determined in Example 4 (that is, the example in FIG. 25) with a vicinity movable object. In this manner, the scoring is more severe in the second scoring criterion than in the first scoring criterion.

### <Checking Front Space>

Next, although risk determiner 105 performs processes similar to steps S331 to S337 in FIG. 22, risk determiner 105 performs processes in steps S335a and S336a, instead of steps S335 and S336.

In other words, in step S332, when risk determiner 105 determines that the driver has visually observed the front space for the time period that is different from the prescribed time period at the predetermined timing (Yes in step S332), risk determiner 105 determines the driving action score for the visual observation of the front space to be 60 points (step S335a). For example, when the driver has glanced at the front space at the predetermined timing, 60 points is determined. While 90 points is determined in Example 3 (that is, the example in FIG. 22) without a vicinity movable object, 60 points, which is lower than 90 points, is determined in Example 4 (that is, the example in FIG. 25) with a vicinity movable object. In this manner, the scoring is more severe in the second scoring criterion than in the first scoring criterion.

Similarly, in step S333, when risk determiner 105 determines that the visual observation of the front space has been performed at the timing that does not match the predetermined timing (Yes in step S333), risk determiner 105 determines the driving action score for the visual observation of the front space to be 40 points (step S336a). While 70 points is determined in Example 3 (that is, the example in FIG. 22) without a vicinity movable object, 40 points, which is lower than 70 points, is determined in Example 4 (that is, the example in FIG. 25) with a vicinity movable object. In this manner, the scoring is more severe in the second scoring criterion than in the first scoring criterion.

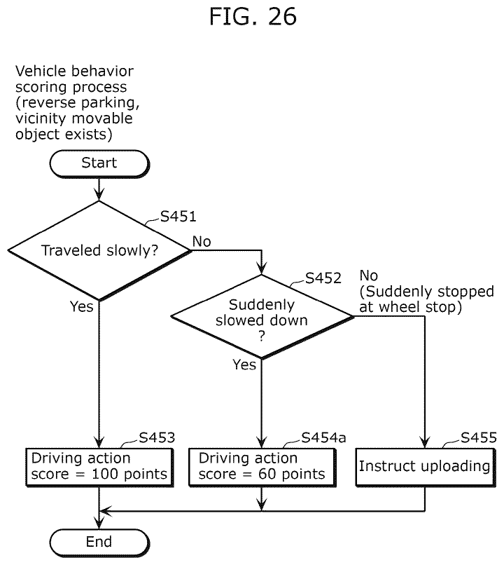

FIG. 26 is a flowchart illustrating a detailed example of the vehicle behavior scoring process. Note that FIG. 26 illustrates detailed processes in step S400 in FIG. 15 in the case where reverse parking is detected as a driving scene in step S1 in FIG. 15, and the second scoring criterion is adopted in step S100 in FIG. 15 (specifically, step S102 in FIG. 9). That is, FIG. 24 illustrates a detailed example of the vehicle behavior scoring process in the case where reverse parking is performed when there is a vicinity movable object.

### <Vehicle Speed>

As illustrated in FIG. 26, although risk determiner 105 performs processes similar to steps S451 to S455 in FIG. 23, risk determiner 105 performs process in step S454a instead of step S454.

In other words, in step S452, when risk determiner 105 determines that vehicle V has suddenly slowed down (Yes in step S452), risk determiner 105 determines the driving action score for the vehicle speed to be 60 points (step S454a). While 90 points is determined in Example 3 (that is, the example in FIG. 23) without a vicinity movable object, 60 points, which is lower than 90 points, is determined in Example 4 (that is, the example in FIG. 26) with a vicinity movable object. In this manner, the scoring is more severe in the second scoring criterion than in the first scoring criterion.

Then, in step S2 in FIG. 15, risk determiner 105 calculates the driving score for the driving of vehicle V by the driver, by performing weighted addition on the driving action score for each of the cognitive action of the left mirror and the right mirror, the cognitive action of the rear, the visual observation of the parking space, the visual observation of the front space, and the vehicle speed.

### Example 5 (Driving Scene: Lane Change to Right, Vicinity Movable Object: None)

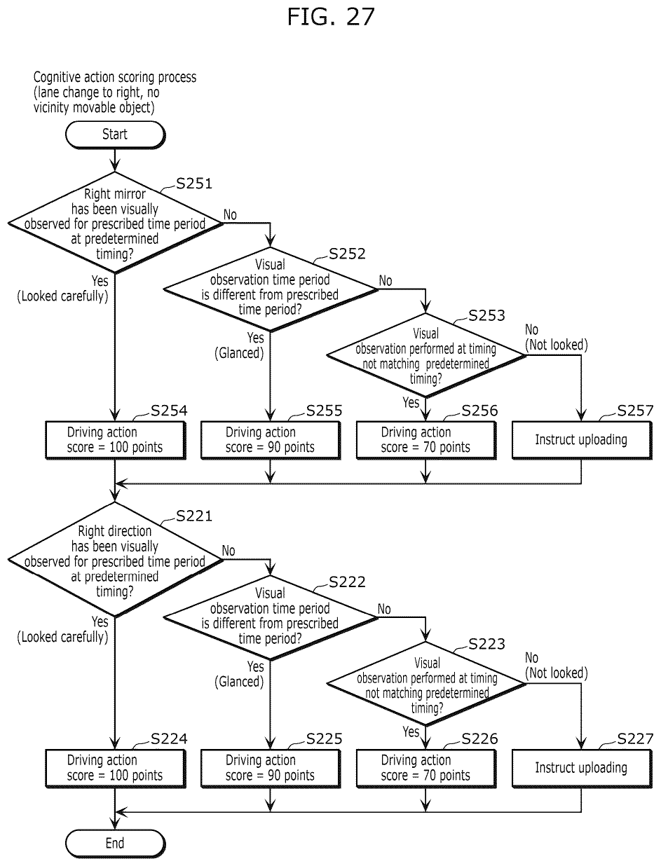

FIG. 27 is a flowchart illustrating a detailed example of the cognitive action scoring process. Note that FIG. 27 illustrates detailed processes in step S200 in FIG. 15 in a case where a lane change to the right is detected as a driving scene in step S1 in FIG. 15, and the first scoring criterion is adopted in step S100 in FIG. 15 (specifically, step S103 in FIG. 9). That is, FIG. 27 illustrates a detailed example of the cognitive action scoring process in the case where the lane change to the right is performed when there is no vicinity movable object. Note that a vicinity movable object is, for example, another vehicle travelling in the same direction as vehicle V.

### <Checking Right Mirror>

First, risk determiner 105 determines whether or not the driver has visually observed the right mirror of vehicle V for the prescribed time period at the predetermined timing, based on the detection result of the cognitive action by cognitive action detector 102 (step S251). The predetermined timing may be, for example, a timing sc3 seconds or less before the lane change is started. sc3 is any numerical value larger than 0. In addition, the prescribed time period may be the same as or different from the prescribed time period in Embodiment 1. For example, the prescribed time period may be a time period within a range from predefined time tg1 to predefined time tg2 (tg2>tg1). Here, when risk determiner 105 determines that the driver has visually observed the right mirror of vehicle V for the prescribed time period at the predetermined timing (Yes in step S251), risk determiner 105 determines the driving action score for the cognitive action of the right mirror to be 100 points (step S254).

On the other hand, when risk determiner 105 determines that the driver has not visually observed the right mirror of vehicle V for the prescribed time period at the predetermined timing (No in step S251), risk determiner 105 determines whether or not the driver has visually observed the right mirror for a time period that is different from the prescribed time period at the predetermined timing (step S252). Here, when risk determiner 105 determines that the driver has visually observed the right mirror for the time period that is different from the prescribed time period at the predetermined timing (Yes in step S252), risk determiner 105 determines the driving action score for the cognitive action of the right mirror to be 90 points (step S255). For example, when the driver has glanced at the right mirror at the predetermined timing, 90 points is determined.

On the other hand, when risk determiner 105 determines that the driver has not visually observed the right mirror for the time period that is different from the prescribed time period at the predetermined timing (No in step S252), risk determiner 105 determines whether or not the visual observation of the right mirror has been performed at the timing that does not match the predetermined timing (step S253). Here, when risk determiner 105 determines that the visual observation of the right mirror has been performed at the timing that does not match the predetermined timing (Yes in step S253), risk determiner 105 determines the driving action score for the cognitive action of the right mirror to be 70 points (step S256). On the other hand, when risk determiner 105 determines that the visual observation of the right mirror has not been performed at the timing that does not match the predetermined timing (No in step S253), risk determiner 105 instructs uploader 107 to upload driving video data (step S257). For example, when the driver has not looked at the right mirror, the uploading is instructed. As a result, the process in step S4 in FIG. 15 is performed.

### <Checking Right Direction>

Furthermore, risk determiner 105 performs the processes in steps S221 to S227 as in the example in FIG. 16.

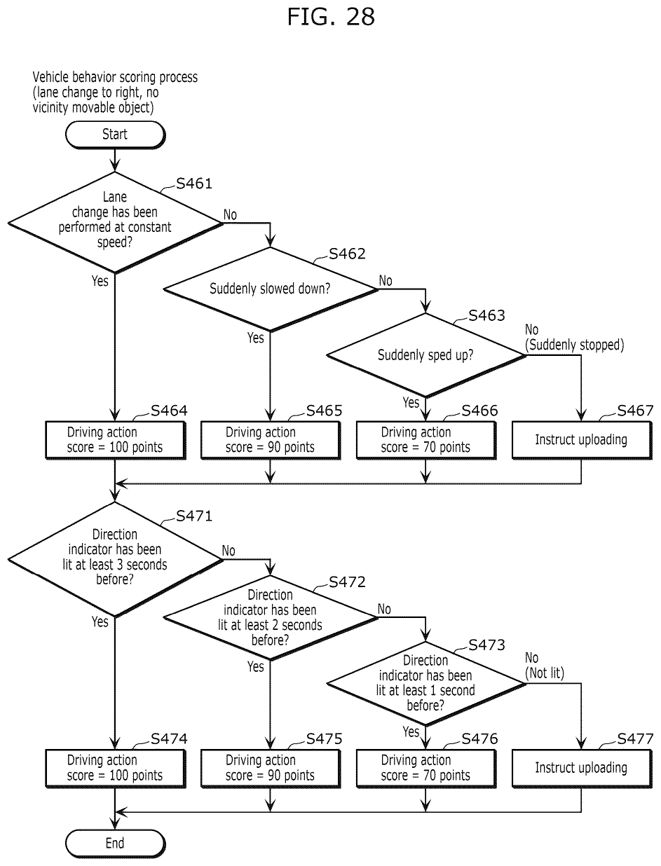

FIG. 28 is a flowchart illustrating a detailed example of the vehicle behavior scoring process. Note that FIG. 28 illustrates detailed processes in step S400 in FIG. 15 in the case where the lane change to the right is detected as a driving scene in step S1 in FIG. 15, and the first scoring criterion is adopted in step S100 in FIG. 15 (specifically, step S103 in FIG. 9). That is, FIG. 28 illustrates a detailed example of the vehicle behavior scoring process in the case where the lane change to the right is performed when there is no vicinity movable object.

### <Vehicle Speed>

First, risk determiner 105 determines whether or not vehicle V has performed the lane change at a constant speed, based on the detection result of the behavior of vehicle V by vehicle behavior detector 103 (step S461). For example, risk determiner 105 determines that vehicle V has performed the lane change at a constant speed, when the difference between vehicle speed va of vehicle V at the time of the lane change and vehicle speed vb of vehicle V immediately before the lane change is within, for example, 10% of vehicle speed vb. Note that the above-described 10% is an example, and the difference is not limited to the above-described numerical value. Here, when risk determiner 105 determines that vehicle V has performed the lane change at a constant speed (Yes in step S461), risk determiner 105 determines the driving action score for the vehicle speed to be 100 points (step S464).

On the other hand, when risk determiner 105 determines that vehicle V has not performed the lane change at a constant speed (No in step S461), risk determiner 105 determines whether or not vehicle V has suddenly slowed down (step S462). Note that sudden stop is not included in the sudden slowdown. For example, here, when risk determiner 105 determines that vehicle V has suddenly slowed down (Yes in step S462), risk determiner 105 determines the driving action score for the vehicle speed to be 90 points (step S465).

On the other hand, when risk determiner 105 determines that vehicle V has not suddenly slowed down (No in step S462), risk determiner 105 determines whether or not vehicle V has suddenly sped up (step S463). Here, when risk determiner 105 determines that vehicle V has suddenly sped up (Yes in step S463), risk determiner 105 determines the driving action score for the vehicle speed to be 70 points (step S466). On the other hand, when risk determiner 105 determines that vehicle V has not suddenly sped up (No in step S463), risk determiner 105 instructs uploader 107 to upload driving video data (step S467). For example, when vehicle V has suddenly stopped, the uploading is instructed. As a result, the process in step S4 in FIG. 15 is performed.

### <Direction Indication>

Furthermore, risk determiner 105 determines whether or not vehicle V has lit the direction indicator at least 3 seconds before the lane change, based on the detection result of the behavior of vehicle V by vehicle behavior detector 103 (step S471). Here, when risk determiner 105 determines that vehicle V has lit the direction indicator (Yes in step S471), risk determiner 105 determines the driving action score for the direction indication to be 100 points (step S474).

On the other hand, when risk determiner 105 determines that vehicle V has not lit the direction indicator at least 3 seconds before the lane change (No in step S471), risk determiner 105 determines whether or not vehicle V has lit the direction indicator at least 2 seconds before the lane change (step S472). Here, when risk determiner 105 determines that vehicle V has lit the direction indicator (Yes in step S472), risk determiner 105 determines the driving action score for the direction indication to be 90 points (step S475).

On the other hand, when risk determiner 105 determines that vehicle V has not lit the direction indicator at least 2 seconds before the lane change (No in step S472), risk determiner 105 determines whether or not vehicle V has lit the direction indicator at least 1 second before the lane change (step S473). Here, when risk determiner 105 determines that vehicle V has lit the direction indicator (Yes in step S473), risk determiner 105 determines the driving action score for the direction indication to be 70 points (step S476). On the other hand, when risk determiner 105 determines that vehicle V has not lit the direction indicator at least 1 second before the lane change (No in step S473), risk determiner 105 instructs uploader 107 to upload driving video data (step S477). As a result, the process in step S4 in FIG. 15 is performed.

Then, in step S2 in FIG. 15, risk determiner 105 calculates the driving score for the driving of vehicle V by the driver, by performing weighted addition on the driving action score for each of the cognitive action of the right mirror, the cognitive action of the right direction, the vehicle speed, and the direction indication.

### Example 6 (Driving Scene: Lane Change to Right, Vicinity Movable Object: Yes)

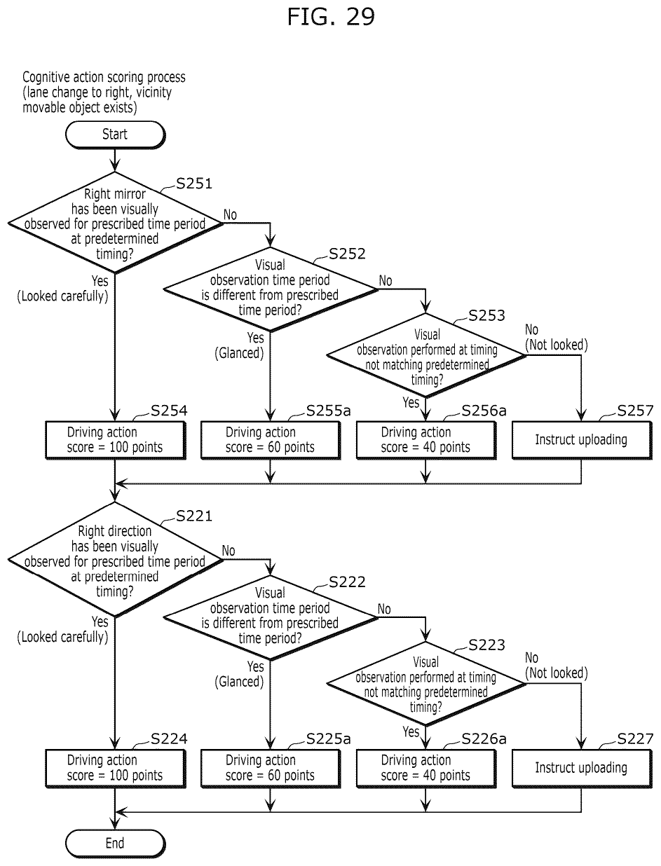

FIG. 29 is a flowchart illustrating a detailed example of the cognitive action scoring process. Note that FIG. 29 illustrates detailed processes in step S200 in FIG. 15 in a case where a lane change to the right is detected as a driving scene in step S1 in FIG. 15, and the second scoring criterion is adopted in step S100 in FIG. 15 (specifically, step S102 in FIG. 9). That is, FIG. 29 illustrates a detailed example of the cognitive action scoring process in the case where the lane change to the right is performed when there is a vicinity movable object.

### <Checking Right Mirror>

First, as illustrated in FIG. 29, although risk determiner 105 performs processes similar to steps S251 to S257 in FIG. 27, risk determiner 105 performs processes in steps S255a and S256a, instead of steps S255 and S256.

In other words, in step S252, when risk determiner 105 determines that the driver has visually observed the right mirror for the time period that is different from the prescribed time period at the predetermined timing (Yes in step S252), risk determiner 105 determines the driving action score for the cognitive action of the right mirror to be 60 points (step S255a). For example, when the driver has glanced at the right mirror at the predetermined timing, 60 points is determined. While 90 points is determined in Example 5 (that is, the example in FIG. 27) without a vicinity movable object, 60 points, which is lower than 90 points, is determined in Example 6 (that is, the example in FIG. 29) with a vicinity movable object. In this manner, the scoring is more severe in the second scoring criterion than in the first scoring criterion.

Similarly, in step S253, when risk determiner 105 determines that the visual observation of the right mirror has been performed at the timing that does not match the predetermined timing (Yes in step S253), risk determiner 105 determines the driving action score for the cognitive action of the right mirror to be 40 points (step S256a). While 70 points is determined in Example 5 (that is, the example in FIG. 27) without a vicinity movable object, 40 points, which is lower than 70 points, is determined in Example 6 (that is, the example in FIG. 29) with a vicinity movable object. In this manner, the scoring is more severe in the second scoring criterion than in the first scoring criterion.

### <Checking Right Direction>

Furthermore, risk determiner 105 performs the processes in steps S221 to S227 as in the example of FIG. 18.

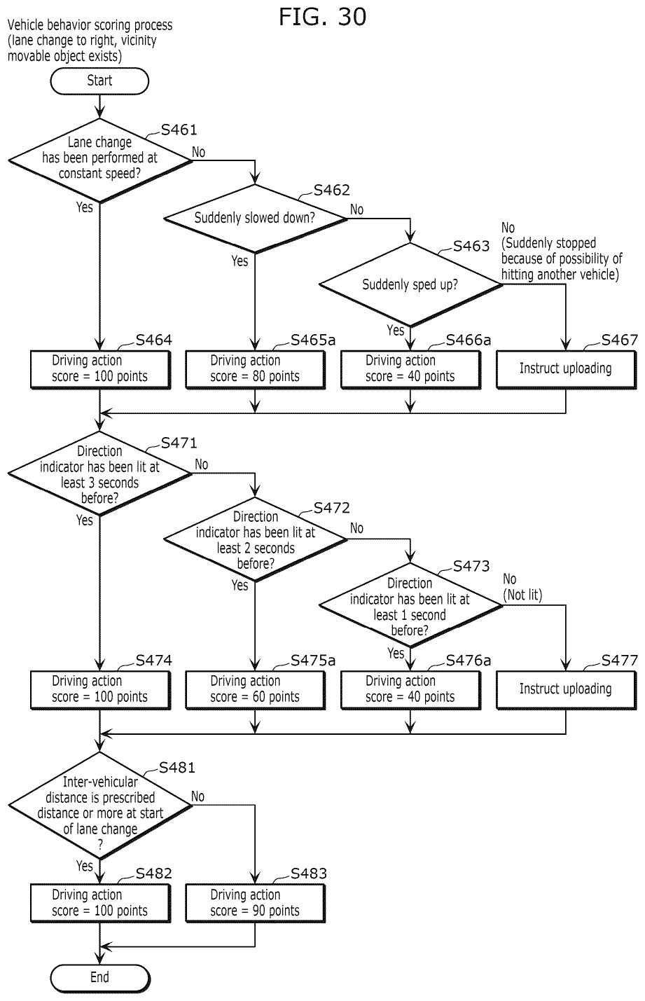

FIG. 30 is a flowchart illustrating a detailed example of the vehicle behavior scoring process. Note that FIG. 30 illustrates detailed processes in step S400 in FIG. 15 in the case where the lane change to the right is detected as a driving scene in step S1 in FIG. 15, and the second scoring criterion is adopted in step S100 in FIG. 15 (specifically, step S102 in FIG. 9). That is, FIG. 30 illustrates a detailed example of the vehicle behavior scoring process in the case where the lane change to the right is performed when there is a vicinity movable object.

### <Vehicle Speed>

First, as illustrated in FIG. 30, although risk determiner 105 performs processes similar to steps S461 to S467 in FIG. 28, risk determiner 105 performs processes in steps S465a and S466a, instead of steps S465 and S466.

In other words, in step S462, when risk determiner 105 determines that vehicle V has suddenly slowed down (Yes in step S462), risk determiner 105 determines the driving action score for the vehicle speed to be 80 points (step S465a). While 90 points is determined in Example 5 (that is, the example in FIG. 28) without a vicinity movable object, 80 points, which is lower than 90 points, is determined in Example 6 (that is, the example in FIG. 30) with a vicinity movable object. In this manner, the scoring is more severe in the second scoring criterion than in the first scoring criterion.

Similarly, in step S463, when risk determiner 105 determines that vehicle V has suddenly sped up (Yes in step S463), risk determiner 105 determines the driving action score for the vehicle speed to be 40 points (step S466a). While 70 points is determined in Example 5 (that is, the example in FIG. 28) without a vicinity movable object, 40 points, which is lower than 70 points, is determined in Example 6 (that is, the example in FIG. 30) with a vicinity movable object. In this manner, the scoring is more severe in the second scoring criterion than in the first scoring criterion.

### <Direction Indication>

Furthermore, although risk determiner 105 performs processes similar to steps S471 to S477 in FIG. 28, risk determiner 105 performs processes in steps S475a and S476a, instead of steps S475 and S476.

In other words, in step S472, when risk determiner 105 determines that vehicle V has lit the direction indicator (Yes in step S472), risk determiner 105 determines the driving action score for the direction indication to be 60 points (step S475a). While 90 points is determined in Example 5 (that is, the example in FIG. 28) without a vicinity movable object, 60 points, which is lower than 90 points, is determined in Example 6 (that is, the example in FIG. 30) with a vicinity movable object. In this manner, the scoring is more severe in the second scoring criterion than in the first scoring criterion.

Similarly, in step S473, when risk determiner 105 determines that vehicle V has lit the direction indicator (Yes in step S473), risk determiner 105 determines the driving action score for the direction indication to be 40 points (step S476a). While 70 points is determined in Example 5 (that is, the example in FIG. 28) without a vicinity movable object, 40 points, which is lower than 70 points, is determined in Example 6 (that is, the example in FIG. 30) with a vicinity movable object. In this manner, the scoring is more severe in the second scoring criterion than in the first scoring criterion.

### <Inter-Vehicular Distance>

Furthermore, risk determiner 105 determines whether or not the inter-vehicular distance in a lane direction between another vehicle travelling in a right adjacent lane and vehicle V is a prescribed distance or more, based on the detection result of the behavior of vehicle V by vehicle behavior detector 103 (step S481). The prescribed distance is a predefined distance, and may be a longer distance when the vehicle speed of vehicle V is faster. Here, when risk determiner 105 determines that the inter-vehicular distance is the prescribed distance or more (Yes in step S481), risk determiner 105 determines the driving action score for the inter-vehicular distance to be 100 points (step S482). On the other hand, when risk determiner 105 determines that the inter-vehicular distance is not the prescribed distance or more (No in step S481), risk determiner 105 determines the driving action score for the inter-vehicular distance to be 90 points (step S483).

Then, in step S2 in FIG. 15, risk determiner 105 calculates the driving score for the driving of vehicle V by the driver, by performing weighted addition on the driving action score for each of the cognitive action of the right mirror, the cognitive action of the right direction, the vehicle speed, the direction indication, and the inter-vehicular distance.

In this manner, in the present embodiment, driving video data is generated by editing one or more items of moving image data by moving image editor 113, and the driving video data is uploaded to management server 200. Accordingly, for example, for each predefined recording time period, even when the moving image data for the recording time period is output from the camera of driver monitor 12 or drive recorder 14, only the portions corresponding to a driving scene are extracted from the one or more items of output moving image data, and are uploaded as the driving video data. In a specific example, the recording time period is one minute. Accordingly, it is possible to prevent uploading, to the server, of the moving image data showing scenes different from the detected driving scene, or even a part of the moving image data. As a result, the transmission load of useless data can be suppressed. Furthermore, when the driving scene is shown across a plurality of items of moving image data, the plurality of items of moving image data can be edited into one item of driving video data. As a result, since the video of the driving scene is displayed without interruption by reproduction of the driving video data, the video of the driving scene can be appropriately checked.

In addition, in the present embodiment, the degree of risk is determined based on the detection result of the visual observation by vicinity visual observation detector 112. Accordingly, for example, in a driving scene in which vehicle V turns right at an intersection, the degree of risk can be determined according to whether or not the driver has visually observed the opposite lane or an oncoming vehicle. That is, when visual observation has not been performed, a high degree of risk can be determined, and conversely, when visual observation has been performed, a low degree of risk can be determined. As a result, the degree of risk can be determined more appropriately.

In addition, in the present embodiment, the degree of risk is determined based on the detection result of the dangerous operation by dangerous operation detector 111. Accordingly, for example, in a driving scene in which vehicle V turns right at an intersection, the degree of risk can be determined according to whether or not the driver has performed an operation of a smartphone or the like as a dangerous operation. That is, when the dangerous operation has not been performed, a low degree of risk can be determined, and conversely, when the dangerous operation has been performed, a high degree of risk can be determined. As a result, the degree of risk can be determined more appropriately.

### Embodiment 3

In Embodiments 1 and 2, when the driving score is less than the risk threshold value, the driving video data is uploaded. On the other hand, in the present embodiment, even in a case where the driving score is less than the risk threshold value, when the driving score is less than the individual risk threshold value associated with the driver, the driving video data is not uploaded. Accordingly, even when the driving of vehicle V by the driver is unsafe driving, it is possible to prevent uploading of the driving video data of the unsafe driving, according to the driver's characteristics or the like, and to achieve reduction of the load related to the uploading. In addition, in the present embodiment, the above-described prescribed time period is determined according to the driver's driving history. Accordingly, the degree of risk of driving of vehicle V can be determined more appropriately.

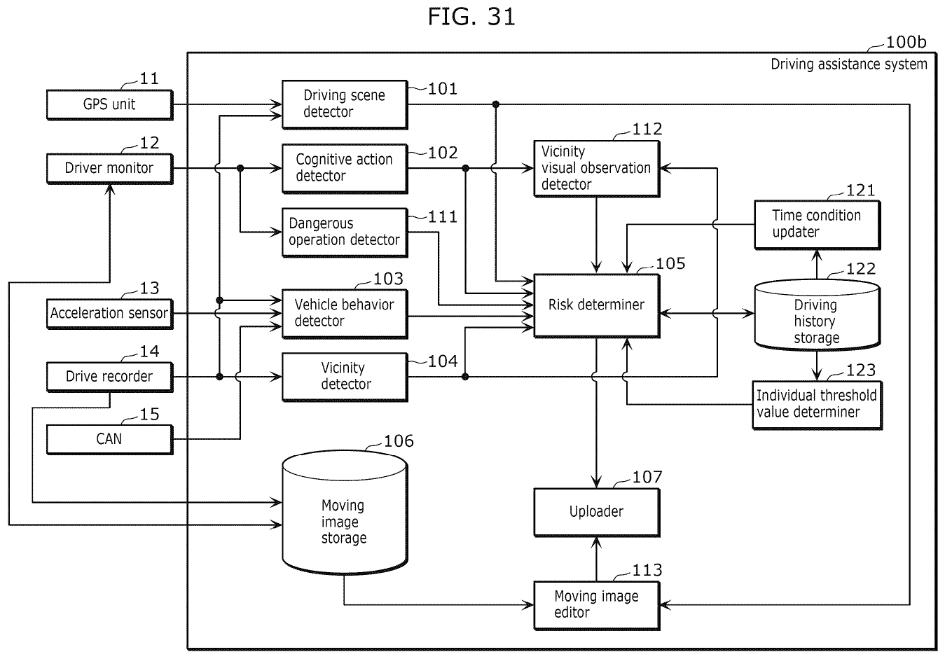

FIG. 31 is a block diagram illustrating an example of the functional configuration of a driving assistance system in the present embodiment.

Driving assistance system 100b in the present embodiment includes each of the structural elements of driving assistance system 100a in Embodiment 2, and further includes time condition updater 121, driving history storage 122, and individual threshold value determiner 123.

Driving history storage 122 is a recording medium that stores driving history data indicating the respective driving histories of a plurality of persons. For example, driving history storage 122 is a hard disk drive, random access memory (RAM), read only memory (ROM), or semiconductor memory. Note that such driving history storage 122 may be volatile, or may be non-volatile.

Time condition updater 121 determines the above-described prescribed time period corresponding to each of the plurality of persons as a time condition, based on the driving histories of the plurality of persons indicated in the driving history data stored in driving history storage 122. Note that time condition updater 121 is also called a time condition determiner.

Individual threshold value determiner 123 determines each of a plurality of individual risk threshold values corresponding to the plurality of persons based on the driving histories of the plurality of persons indicated in the driving history data stored in driving history storage 122.

When risk determiner 105 in the present embodiment determines that the driving score is less than the risk threshold value, risk determiner 105 further selects the individual risk threshold value associated with the driver of vehicle V from the plurality of individual risk threshold values determined by individual threshold value determiner 123. Then, risk determiner 105 determines whether or not the driving score is less than the selected individual risk threshold value. Here, when risk determiner 105 determines that the driving score is less than the individual risk threshold value, risk determiner 105 instructs uploader 107 to upload driving video data. That is, when the driving score is less than the risk threshold value and is less than the individual risk threshold value, uploader 107 in the present embodiment uploads the driving video data to management server 200.

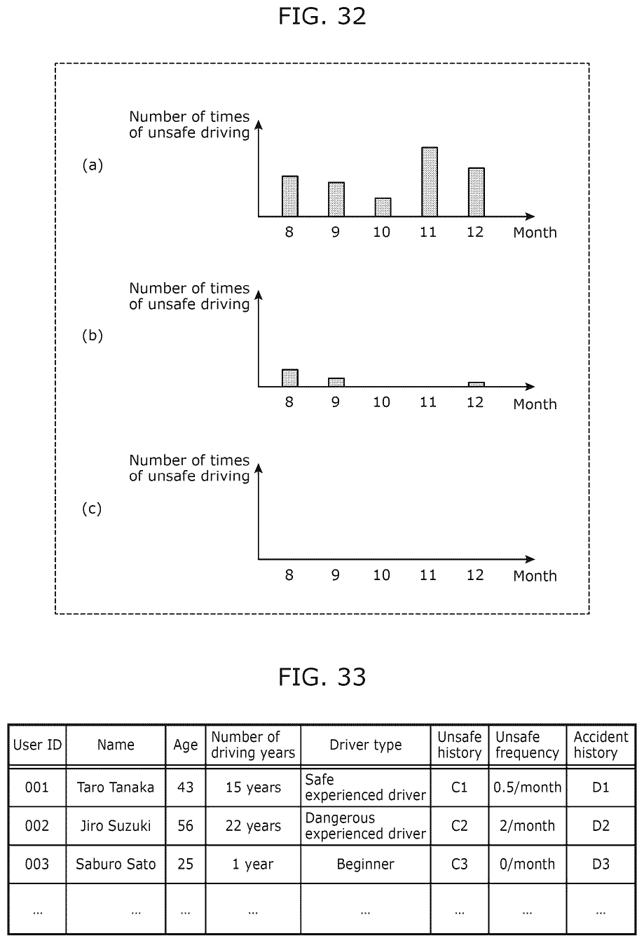

FIG. 32 is a diagram for describing an example of the driving history data stored in driving history storage 122. For example, the driving history data indicates the number of times of unsafe driving per month for each of the plurality of persons. Note that the plurality of persons are persons who can be drivers of vehicle V. In addition, the number of times of unsafe driving is the number of times unsafe driving has occurred. In addition, each of (a) to (c) in FIG. 32 is a graph illustrating the number of times of unsafe driving for each month. (a) in FIG. 32 is a graph illustrating the number of times of unsafe driving of a person who performs dangerous driving, (b) in FIG. 32 is a graph illustrating the number of times of unsafe driving of a person who performs safe driving, and (c) in FIG. 32 is a graph illustrating the number of times of unsafe driving of a person with little driving experience.

Specifically, the driving history data for the person who performs dangerous driving indicates that the number of times of unsafe driving for each month is high as illustrated in (a) in FIG. 32. In addition, the driving history data for the person who performs safe driving indicates that the number of times of unsafe driving for each month is low as illustrated in (b) in FIG. 32. In addition, the driving history data for the person with little driving experience indicates that unsafe driving has not occurred in each month as illustrated in (c) in FIG. 32.

FIG. 33 is a diagram illustrating a more specific example of the driving history data stored in driving history storage 122.

For example, as illustrated in FIG. 31, the driving history data indicates, for each of the plurality of persons, the person's user ID, name, age, number of driving years, driver type, unsafe history, unsafe frequency, and accident history as the driving history by associating these with each other. The user ID is the identification information of the person corresponding to the user ID. The number of driving years indicate the number of years of experience that a person corresponding to the number of driving years has driven a vehicle. The number of years may be the number of years the person has driven the vehicle as a business. The driver type includes, for example, a safe experienced driver, a dangerous experienced driver, and a beginner. The safe experienced driver is a type of person whose number of driving years is longer than a first career threshold value, and whose unsafe frequency is lower than a first frequency threshold value. The dangerous experienced driver is a type of person whose number of driving years is longer than the first career threshold value, and whose unsafe frequency is higher than a second frequency threshold value. The beginner is a type of person whose number of driving years is shorter than a second career threshold value. Note that the second career threshold value may be smaller than or the same as the first career threshold value. In addition, the first frequency threshold value may be smaller than or the same as the second frequency threshold value.

The unsafe history indicates the number of times of unsafe driving per month of the person corresponding to the unsafe history. For example, unsafe history C1 is expressed as the graph illustrated in (b) in FIG. 32, unsafe history C2 is expressed as the graph illustrated in (a) in FIG. 32, and unsafe history C3 is expressed as the graph illustrated in (c) in FIG. 32. The unsafe frequency is a moving average value of the number of times of unsafe driving per month of the person corresponding to the unsafe frequency. Note that the moving average value may be a weighted moving average value. In addition, the moving average value may be an average value for the latest three months, or may be an average value of a period of not only three months but two months, four months or more. The accident history indicates the number of accidents the person corresponding to the accident history caused in the past. For example, in the driving history data, accident history D1 is associated with a person with a user ID “001”, accident history D2 is associated with a person with a user ID “002”, and accident history D3 is associated with a person with a user ID “003”.

Individual threshold value determiner 123 determines, for each user ID indicated in the driving history data, the individual risk threshold value of the person identified by the user ID, based on the person's driving history. For example, individual threshold value determiner 123 identifies the driver of vehicle V based on the moving image data that is output from driver monitor 12, and specifies the user ID of the driver. Then, individual threshold value determiner 123 refers to the driving history data stored in driving history storage 122, and specifies the driver type associated with the user ID. For example, when the specified driver type is the safe experienced driver, individual threshold value determiner 123 determines x1[%] of the risk threshold value to be the above-described driver's individual risk threshold value. Note that x1 is a numerical value larger than 0 and less than 100. In addition, for example, when the specified driver type is the dangerous experienced driver, individual threshold value determiner 123 determines x2[%] of the risk threshold value to be the above-described driver's individual risk threshold value. Note that x2 is a numerical value larger than 0 and less than 100, and is larger than x1. In addition, for example, when the specified driver type is the beginner, individual threshold value determiner 123 determines the risk threshold value to be the above-described driver's individual risk threshold value.

Accordingly, when the driver is the beginner, the driving video data of all the unsafe driving by the driver is uploaded. In addition, when the driver is the dangerous experienced driver, much of the driving video data of all the unsafe driving by the driver is uploaded. On the other hand, when the driver is the safe experienced driver, the number of items of driving video data to be uploaded from among the driving video data of all the unsafe driving by the driver is suppressed.

Note that individual threshold value determiner 123 may determine a person's individual risk threshold value according to the person's unsafe frequency, regardless of the driver type. For example, individual threshold value determiner 123 may determine a larger individual risk threshold value for a person when the person's unsafe frequency is higher, and conversely, threshold value determiner 123 may determine a smaller individual risk threshold value to the person when the person's unsafe frequency is lower.

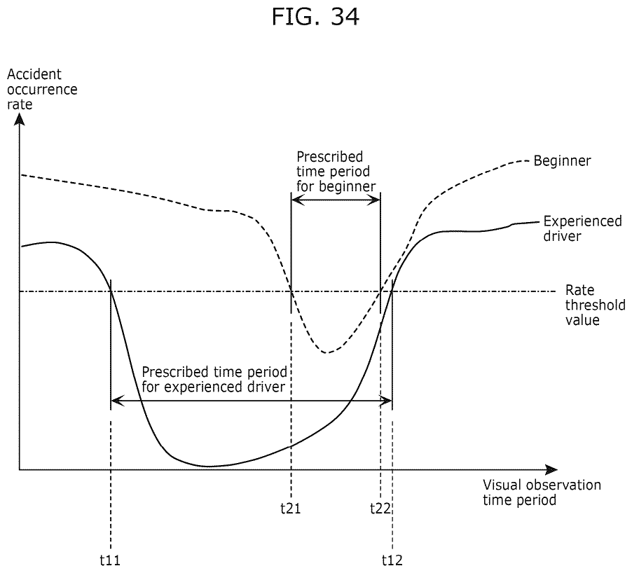

FIG. 34 is a diagram for describing an example of the process operation of time condition updater 121. Note that, a horizontal axis of a graph in FIG. 34 represents the visual observation time period, and a vertical axis represents the accident occurrence rate.

Time condition updater 121 determines the prescribed time period for the experienced driver, the prescribed time period for the beginners, and the like, based on the driving history data stored in driving history storage 122. Note that the prescribed time period for the experienced driver may be common to the prescribed time period for the safe experienced driver, and the prescribed time period for the dangerous experienced driver. In addition, every time the driving history data is updated, time condition updater 121 may update the above-described prescribed time period based on the latest driving history data.

Specifically, as illustrated in FIG. 34, time condition updater 121 collects statistics on the visual observation time period and the rate at which the accident has occurred due to driving with the visual observation time period (that is, the accident occurrence rate) for each driver type, based on the driving history data. Here, there is a tendency that the accident occurrence rate is higher when the visual observation time period is excessively shorter, and similarly, the accident occurrence rate is higher when the visual observation time period is excessively longer. Therefore, time condition updater 121 determines, for each driver type, the visual observation time period equal to or less than a predefined threshold value to be the prescribed time period. That is, time condition updater 121 determines each visual observation time period of visual observation time period t11 to t12 to be the prescribed time period for the experienced driver. Similarly, time condition updater 121 determines each visual observation time period of visual observation time period t21 to t22 to be the prescribed time period for the beginner. Accordingly, the prescribed time period corresponding to the driver type of each of the plurality of persons is determined based on the driving histories of the plurality of persons. That is, the prescribed time period is determined according to the driver's driving skill level.

Risk determiner 105 determines the driving action score by using the prescribed time period determined by time condition updater 121. That is, risk determiner 105 identifies the driver of vehicle V based on the moving image data that is output from driver monitor 12, and specifies the user ID of the driver. Furthermore, risk determiner 105 refers to the driving history data stored in driving history storage 122, and specifies the driver type associated with the user ID. Then, risk determiner 105 identifies the prescribed time period for the specified driver type by querying time condition updater 121. In other words, risk determiner 105 selects the prescribed time period for the specified driver type from a plurality of prescribed time periods determined by time condition updater 121. Risk determiner 105 performs determination of the driving action score for a cognitive action and the like by using the prescribed time period identified or selected in this manner.

That is, risk determiner 105 in the present embodiment selects the prescribed time period associated with the driver of vehicle V from the plurality of prescribed time periods determined by time condition updater 121. Then, risk determiner 105 determines the degree of risk by comparing the time period during which the cognitive action detected by cognitive action detector 102 has been performed with the selected prescribed time period. Accordingly, since the prescribed time period according to the driver is selected, and the degree of risk is determined by comparison between the time period during which the cognitive action has been performed by the driver and the prescribed time period, the risk can be determined more appropriately. For example, an experienced driver and a beginner driver tend to differ in the time period for a cognitive action required for safe driving (for example, the visual observation time period of the right direction). Therefore, the degree of risk of driving by the driver can be appropriately determined by using the prescribed time period according to the driver.

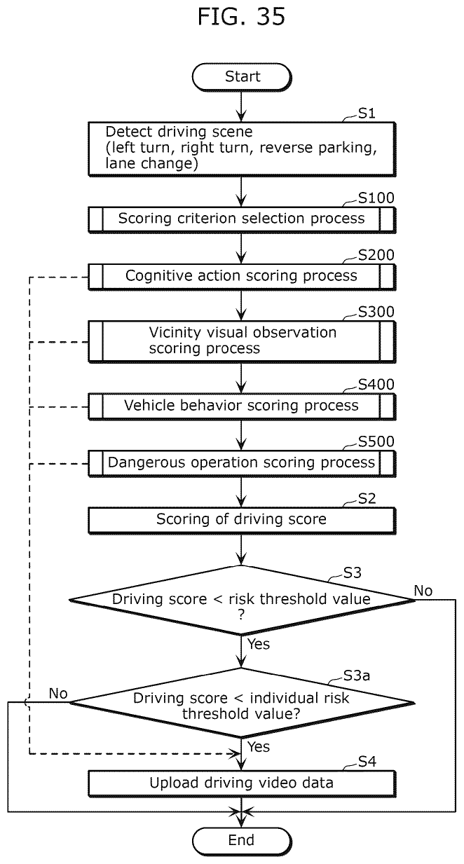

FIG. 35 is a flowchart illustrating an example of the overall process operation of driving assistance system 100b in the present embodiment.

Driving assistance system 100b in the present embodiment performs process operation of driving assistance system 100a illustrated in FIG. 15, and further performs a process in step S3a.

That is, when risk determiner 105 determines that the driving score scored in step S2 is less than the risk threshold value (Yes in step S3), risk determiner 105 determines whether or not the driving score is less than the individual risk threshold value (step S3a). Note that the individual risk threshold value is a threshold value determined for the driver of vehicle V by individual threshold value determiner 123. Then, when risk determiner 105 determines that the driving score scored in step S2 is less than the individual risk threshold value (Yes in step S3a), risk determiner 105 instructs uploader 107 to upload driving video data. As a result, uploader 107 uploads the driving video data to management server 200 (step S4).

On the other hand, even in the case where the driving score is less than the risk threshold value (Yes in step S3), when risk determiner 105 determines that the driving score is not less than the individual risk threshold value (No in step S3a), risk determiner 105 ends the process for the driving scene detected in step S1, without instructing the uploading.

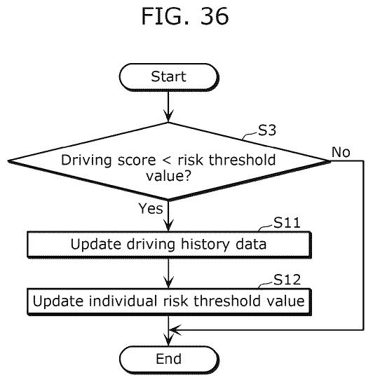

FIG. 36 is a flowchart illustrating an example of the process operation regarding the driving history by risk determiner 105 and individual threshold value determiner 123 in the present embodiment.

As described above, risk determiner 105 determines whether or not the driving score scored in step S2 in FIG. 35 is less than the risk threshold value (step S3). Here, when risk determiner 105 determines that the driving score is less than the risk threshold value (Yes in step S3), risk determiner 105 updates the driving history data stored in driving history storage 122 (step S11). That is, risk determiner 105 updates the unsafe history and the unsafe frequency that are illustrated in FIG. 33 of the driving history data.

After the process in step S11, individual threshold value determiner 123 updates the individual risk threshold value of the driver corresponding to the above-described driving score, based on the updated unsafe frequency of the driving history data (step S12).

In this manner, in the present embodiment, even in a case where the driving score is less than the risk threshold value, when the driving score is not less than the individual risk threshold value associated with the driver, uploading of the driving video data is not performed. Accordingly, even when unsafe driving has been performed by the driver, whether or not uploading of the driving video data is performed can be switched according to the driver. For example, a small individual risk threshold value is associated with an experienced driver who usually performs safe driving. As a result, even when the driver happens to perform unsafe driving, uploading of the driving video data can be prevented. Therefore, optimization of the uploading according to drivers can be achieved. By associating a small individual risk threshold value with an experienced driver who has been performing safe driving over many years (that is, an experienced safe driver), the driving video data can be less likely to be uploaded. On the other hand, by associating a large individual risk threshold value with an experienced driver who has been performing dangerous driving over many years (that is, an experienced dangerous driver), the driving video data can be more likely to be uploaded. As a result, optimization and improvement of efficiency of uploading of the driving video data can be achieved.

In addition, in the present embodiment, each of the plurality of individual risk threshold values corresponding to the plurality of persons is determined based on the driving histories of the plurality of persons. Accordingly, for each of the plurality of persons, the individual risk threshold value can be determined according to the person's type as a driver (that is, the driver type).

### Variation

The above-described individual risk threshold value is the threshold value used in common for driving by a person who drive vehicle V, no matter what kind of driving is performed. On the other hand, in the present variation, in each scene of driving (that is, each driving scene), or at each location (or an area) where driving is performed, an individual risk threshold value according to the driving scene or the location is used. Such an individual risk threshold value is also called a conditional individual risk threshold value. In addition, an individual risk threshold value according to a driving scene is also called a conditional individual risk threshold value for a driving scene, and an individual risk threshold value according to a location (or an area) is also called a conditional individual risk threshold value for a location.

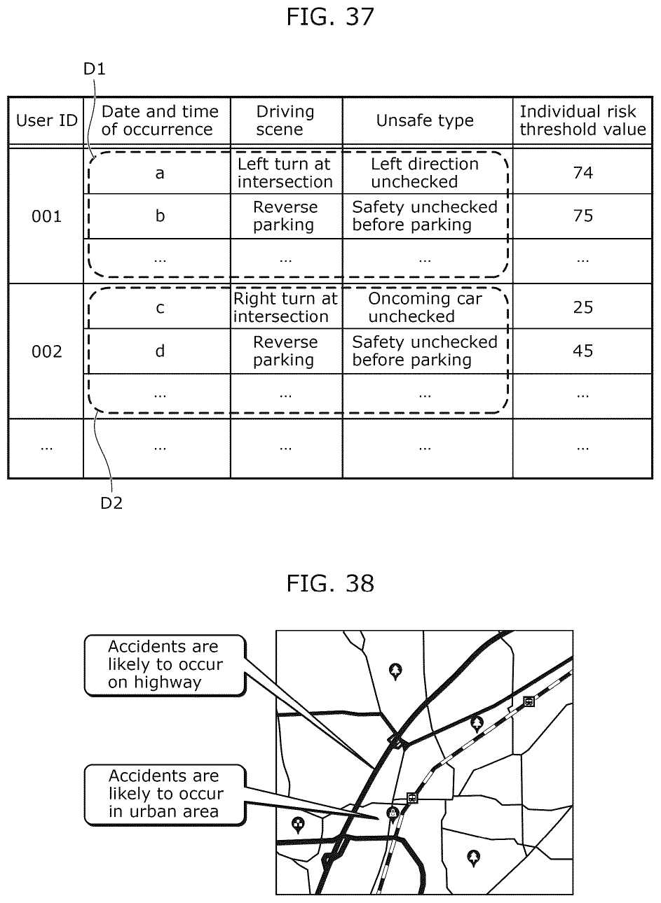

FIG. 37 is a diagram illustrating an example of the accident history included in the driving history data.

For example, the accident history includes the date and time of occurrence of an accident that has occurred due to driving, the driving scene of the driving, and the unsafe type considered to be the cause of the accident. Note that the date and time of occurrence indicate the year, month, and date and the time. The unsafe type is the type of driving distinguished by the driving action with the lowest driving action score in the driving scene.

In a specific example, accident history D1 indicates that the person with the user ID “001” has caused an accident of the unsafe type “left direction unchecked” in a driving scene “left turn at intersection” at the date and time of occurrence “a”. The driving scene “left turn at intersection” is the above-described driving scene of a left turn at an intersection. The unsafe type “left direction unchecked” is the type of driving with the lowest driving action score for the cognitive action of the left direction among all the driving action scores scored for the driving in the accident.

Individual threshold value determiner 123 determines the individual risk threshold value of the person with the user ID “001” based on the driver type of the driving history data illustrated in FIG. 33. Furthermore, individual threshold value determiner 123 determines the individual risk threshold value for each driving scene of the person with the user ID “001” as a conditional individual risk threshold value for the driving scene, based on the above-described accident history D1. For example, for each driving scene illustrated in accident history D1, individual threshold value determiner 123 adds the difference value according to the number of times of occurrence of accident in the driving scene to the individual risk threshold value. The difference value may be a negative value or may be a positive value. More specifically, when the number of times of occurrence of accident is higher, individual threshold value determiner 123 adds a larger positive difference value to the individual risk threshold value. Accordingly, the individual risk threshold value for each driving scene, that is, the conditional individual risk threshold value for the driving scene, is determined.

In step S3a of FIG. 35, risk determiner 105 compares, with the driving score scored in step S2, the conditional individual risk threshold value for the driving scene determined by individual threshold value determiner 123 for the driving scene detected in step S1 and the driver of vehicle V. As a result, the higher the number of times of occurrence of accident in a driving scene, the more likely the driving video data of the unsafe driving in the driving scene is uploaded.

FIG. 38 is a diagram for describing a conditional individual risk threshold value for a location. Note that FIG. 38 illustrates a map of a location where vehicle V travels.

For example, the person with the user ID “001” drives vehicle V as a driver. For the driver, the number of times of occurrence of accident on highways is high, and the number of times of occurrence of accident in locations other than highways is low. In this case, it is desirable that the person's individual risk threshold value is large for driving on highways, and small for driving at the locations other than highway. In addition, the person with the user ID “002” drives vehicle V as a driver. For the driver, the number of times of occurrence of accident in urban areas is high, and the number of times of occurrence of accident in locations other than urban areas is low. In this case, it is desirable that the person's individual risk threshold value is large for driving in urban areas, and small in driving in locations other than urban areas.

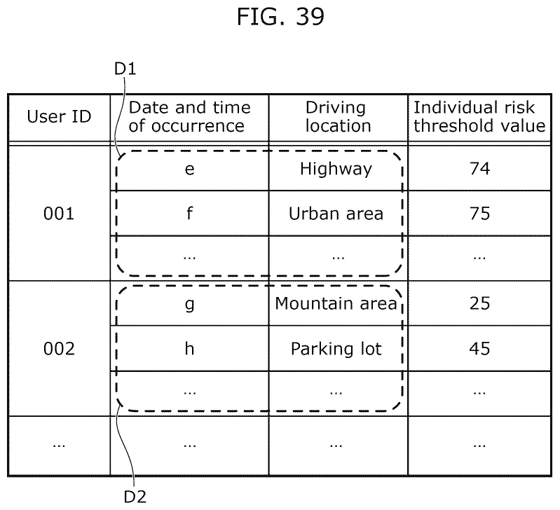

Therefore, as illustrated in an example in FIG. 39, the accident history may indicate driving locations.

FIG. 39 is a diagram illustrating another example of the accident history included in the driving history data.

For example, the accident history includes the date and time of occurrence of an accident that has occurred due to driving, and the location of the driving. In a specific example, accident history D1 indicates that the person with the user ID “001” has caused an accident at a location “highway” at the date and time of occurrence “e”. Note that the location may be a location identified by a position signal that is output from GPS unit 11.

Individual threshold value determiner 123 determines the individual risk threshold value of the person with the user ID “001” based on the driver type of the driving history data illustrated in FIG. 33. Furthermore, individual threshold value determiner 123 determines the individual risk threshold value for each location of driving by the person with the user ID “001” as a conditional individual risk threshold value of the location, based on the above-described accident history D1. For example, for each location indicated in accident history D1, individual threshold value determiner 123 adds the difference value according to the number of times of occurrence of accident at the location to the individual risk threshold value. The difference value may be a negative value or may be a positive value. More specifically, when the number of times of occurrence of accident at the location is higher, individual threshold value determiner 123 adds a larger positive difference value to the individual risk threshold value. Accordingly, the individual risk threshold value for each location, that is, the conditional individual risk threshold value for the location, is determined.

In step S3a of FIG. 35, risk determiner 105 compares, with the driving score scored in step S2, the conditional individual risk threshold value for the location determined by individual threshold value determiner 123 for the location where driving of vehicle V is performed and the driver of vehicle V. As a result, the higher the number of times of occurrence of accident at the location, the more likely the driving video data of the unsafe driving at the location is uploaded.

Note that the accident history may include the content illustrated in FIG. 37 and the content illustrated in FIG. 39. That is, the accident history may include the date and time of occurrence of an accident that has occurred due to driving, the driving scene of the driving, and the location of the driving. In this case, for each combination of a driving scene and a location illustrated in the accident history, individual threshold value determiner 123 adds the difference value according to the number of times of occurrence of accident for the combination to the individual risk threshold value. More specifically, when the number of times of occurrence of accident in the driving scene included in the combination and at the location included in the combination is higher, individual threshold value determiner 123 adds a larger positive difference value to the individual risk threshold value. Accordingly, the individual risk threshold value for the combination, that is, the individual risk threshold value for each combination of a driving scene and a location, is determined. This individual risk threshold value for each combination of a driving scene and a location is also called the conditional individual risk threshold value for the driving scene and the location.

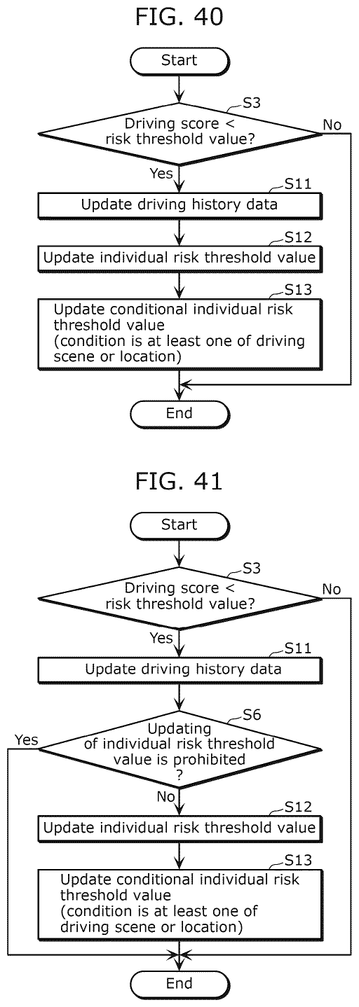

FIG. 40 is a flowchart illustrating an example of the process operation regarding the driving history by risk determiner 105 and individual threshold value determiner 123 in the present variation.

As described above, risk determiner 105 determines whether or not the driving score scored in step S2 is less than the risk threshold value (step S3). Here, when risk determiner 105 determines that the driving score is less than the risk threshold value (Yes in step S3), risk determiner 105 updates the driving history data stored in driving history storage 122 (step S11). That is, risk determiner 105 updates the unsafe frequency illustrated in FIG. 33 of the driving history data.

After the process in step S11, individual threshold value determiner 123 updates the individual risk threshold value of the driver of vehicle V, based on the unsafe frequency of the updated driving history data (step S12). Furthermore, individual threshold value determiner 123 updates the conditional individual risk threshold value of the driver of vehicle V, based on the accident history of the updated driving history data (step S13). The conditional individual risk threshold value may be a conditional individual risk threshold value for a driving scene, or may be a conditional individual risk threshold value for a location. In addition, the conditional individual risk threshold value may be a conditional individual risk threshold value for a driving scene and a location.

FIG. 41 is a flowchart illustrating another example of the process operation regarding the driving history by risk determiner 105 and individual threshold value determiner 123 in the present variation.

This process operation regarding the driving history includes the process in each of the steps of the flowchart illustrated in FIG. 40, and further includes the process in step S6.

For example, when the driving history data stored in driving history storage 122 is updated (step S11), individual threshold value determiner 123 determines whether or not updating of the individual risk threshold value is prohibited (step S6). For example, based on the accident history, when a predetermined time period has not elapsed since the date and time of occurrence of the latest accident, individual threshold value determiner 123 determines that updating of the individual risk threshold value is prohibited. The predetermined time period may be, for example, one year, may be a time period other than one year, or may be dependent on the interval between the occurrences of accidents. Conversely, when the predetermined time period has elapsed since the date and time of occurrence of the accident, individual threshold t value determiner 123 determines that updating of the individual risk threshold value is not prohibited. Then, when individual threshold value determiner 123 determines that updating of the individual risk threshold value is not prohibited (No in step S6), individual threshold value determiner 123 performs the processes in steps S12 and S13. On the other hand, when individual threshold value determiner 123 determines that updating of the individual risk threshold value is prohibited (Yes in step S6), individual threshold value determiner 123 ends the process operation regarding the individual risk threshold value, without performing the processes in steps S12 and S13.

In this example in FIG. 41, since the process in step S6 is performed, the individual risk threshold value and the conditional individual risk threshold value can be maintained at appropriate values. That is, immediately after the occurrence of an accident, that is, in a predetermined time period from the date and time when the latest accident has occurred, even a driver who usually performs unsafe driving tends to refrain from performing unsafe driving. During such a predetermined time period, when the individual risk threshold value and the conditional individual risk threshold value are updated to large values since the number of times of unsafe driving is low, there is a possibility that uploading of appropriate driving video data is inhibited. Therefore, with the process in step S6, it is possible to prevent uploading of appropriate driving video data from being inhibited, and to maintain the individual risk threshold value and the conditional individual risk threshold value at appropriate values.

Note that, in the example in FIG. 41, when the predetermined time period has not elapsed since the date and time of occurrence of the latest accident, although individual threshold value determiner 123 prohibits updating of the individual risk threshold value, individual threshold value determiner 123 may prevent, rather than prohibit, updating of the individual risk threshold value. That is, individual threshold value determiner 123 may limit the amount of change in the individual risk threshold value. For example, when the predetermined time period has elapsed since the date and time of occurrence of the latest accident by a person, individual threshold value determiner 123 determines the value according to the person's unsafe frequency as the individual risk threshold value. On the other hand, when the predetermined time period has not elapsed since the date and time of occurrence of the latest accident by the person, individual threshold value determiner 123 determines the value according to the person's unsafe frequency as a temporary individual risk threshold value in a manner similar to the above. Then, individual threshold value determiner 123 calculates the difference value by multiplying the difference between the individual risk threshold value immediately before the updating and the temporary individual risk threshold value by a weight smaller than one. Individual threshold value determiner 123 determines the person's individual risk threshold value by adding the difference value to the individual risk threshold value immediately before the updating.

In this manner, in the present variation, individual threshold value determiner 123 determines the conditional individual risk threshold value for a driving scene. That is, for each of a plurality of combinations, individual threshold value determiner 123 determines the individual risk threshold value corresponding to the combination. Each of the plurality of combinations is a combination including one of a plurality of persons including a driver of vehicle V, and one of a plurality of driving scenes. Then, risk determiner 105 selects, from the plurality of individual risk threshold values, the individual risk threshold value associated with the combination of a driving scene detected by driving scene detector 101 and the driver of vehicle V as the conditional individual risk threshold value for the driving scene. Accordingly, since the individual risk threshold value corresponding to the driver who has performed unsafe driving, and to the driving scene in which the unsafe driving has been performed is selected and used, further optimization and improvement of efficiency of uploading of the driving video data can be achieved. For example, even if the driver is a driver who usually performs save driving, if the driver tends to perform unsafe driving in a driving scene of reverse parking, a large individual risk threshold value can be selected for the driver only when reverse parking is performed. As a result, the driving video data can be more likely to be uploaded only when reverse parking is performed.

In addition, in the present variation, individual threshold value determiner 123 determines the conditional individual risk threshold value for a location. That is, for each of a plurality of combinations, individual threshold value determiner 123 determines the individual risk threshold value corresponding to the combination. Each of the plurality of combinations is a combination including one of a plurality of persons including a driver of vehicle V, and one of a plurality of locations. Then, risk determiner 105 selects, from the plurality of individual risk threshold values, the individual risk threshold value associated with the combination of the driver of vehicle V and a location where vehicle V is traveling in a driving scene detected by driving scene detector 101, as the conditional individual risk threshold value for the location. Accordingly, since the individual risk threshold value corresponding to the driver who has performed unsafe driving, and to the location in the driving scene in which the unsafe driving has been performed is selected and used, further optimization and improvement of efficiency of uploading of the driving video data can be achieved. For example, even if the driver is a driver who usually performs safe driving, if the driver tends to perform unsafe driving at the location of a highway, a large individual risk threshold value can be selected for the driver only while the vehicle is travelling on a highway. As a result, the driving video data can be more likely to be uploaded only while the vehicle is travelling on a highway.

Although the driving assistance system according to one or more aspects of the present disclosure has been described above based on the one or more embodiments and variations, the present disclosure is not limited to these embodiments and variations. Various modifications to the above-described embodiments according to the present disclosure described above that may be conceived by those skilled in the art may also be included within the scope of the present disclosure, unless such modifications depart from the essence of the present disclosure. Moreover, any combinations of the embodiments and variations may also be included in the present disclosure.

For example, in each of the above-described embodiments and variation, although the driving video data is transmitted from vehicle V to management server 200, the timing of the transmission may be real time, or need not be real time. The real time is the timing when unsafe driving has been determined. On the other hand, the timing that is not the real time may be, for example, the timing when vehicle V has returned to a parking lot of a person or a company owning vehicle V.

In addition, at least one structural element included in each of driving assistance systems 100, 100a, and 100b may be included in a cloud server such as management server 200, instead of the driving assistance system. Several patterns are assumed in which the at least one structural element is included in a cloud server.

In a first pattern, the at least one structural element included in the cloud server is a plurality of structural elements except for moving image storage 106 and uploader 107 of a plurality of structural elements included in each of driving assistance systems 100, 100a, and 100b. In this case, the cloud server obtains an output (except for moving image data) from each sensor, such as GPS unit 11, provided in vehicle V via communication network Nt whenever necessary. Then, risk determiner 105 included in the cloud server requests uploader 107 provided in vehicle V to transmit the driving video data corresponding to a driving scene in which unsafe driving has been performed. Then, in response to the request, the cloud server obtains the driving video data transmitted from uploader 107 of vehicle V via communication network Nt.

In a second pattern, the at least one structural element included in the cloud server is risk determiner 105. In this case, a plurality of detectors, such as driving scene detector 101 and cognitive action detector 102, provided in vehicle V transmit detection results to risk determiner 105 via communication network Nt. Then, risk determiner 105 included in the cloud server obtains those transmitted detection results, and determines the degree of risk of driving. Then, based on the determination result, risk determiner 105 may request uploader 107 provided in vehicle V to transmit the driving video data corresponding to a driving scene at the time when unsafe driving has been performed. In addition, when all the moving image data obtained by vehicle V is transmitted from vehicle V to the cloud server, risk determiner 105 may generate, from all the moving image data, the driving video data corresponding to a driving scene at the time when unsafe driving has been performed.

In a third pattern, all the structural elements included in each of driving assistance systems 100, 100a, and 100b are included in the cloud server. In this case, outputs from all the sensors, such as GPS unit 11, provided in vehicle V, are transmitted to the cloud server, and all the processes similar to those in each of the above-described embodiments and variation are performed by the cloud server. Note that the transmission of the outputs from all the above-described sensors to the cloud server may be performed via Wi-Fi (registered trademark), when vehicle V enters a communication area of the Wi-Fi. That is, the outputs from all the sensors are accumulated in vehicle V, and all the accumulated outputs are transmitted to the cloud server when vehicle V enters the above-described communication area. Note that the communication area of the Wi-Fi (registered trademark) is, for example, a parking lot of a person or a company owning vehicle V described above. In such a third pattern, the system configuration included in vehicle V can be significantly simplified.

In addition, in respective flowcharts in FIG. 15 and FIG. 35, the processes in step S300 and step S500 may be performed or need not be performed, according to the driving scene detected in step S1. In addition, the item of the driving action score scored in each of step S200, step S300, step S400, and step S500 in FIG. 8, FIG. 15, and FIG. 35 may be determined according to the driving scene detected in step S1. Note that the item of the driving action score is, for example, the cognitive action of the right direction, the visual observation of the opposite lane, the vehicle speed, the direction indication, the smartphone operation, or the like.

Note that each of the structural elements according to the above-described embodiment may be configured in the form of dedicated hardware or a circuit, or may be implemented by executing a software program suited to each of the structural elements. Each of the structural elements may be implemented by a program executor such as a central processing unit (CPU) or a processor reading out and executing the software program recorded in a recording medium such as a hard disk or semiconductor memory. Here, the program that is software implementing a system such as the driving assistance system and so forth according to each of the above-described embodiments causes a computer to execute each step of the flowcharts illustrated in FIGS. 8 to 11, 15 to 30, 35, 36, 40, and 41.

Note that the following cases are also included in the present disclosure.

(1) The above-described system may specifically be a computer system including, for example, a microprocessor, read only memory (ROM), random access memory (RAM), a hard disk unit, a display unit, a keyboard, and a mouse. The RAM or the hard disk unit stores computer programs. At least one of the above-described devices achieves its function as a result of the microprocessor operating in accordance with the computer programs. The computer programs as used herein are configured by a combination of a plurality of instruction codes that indicate commands given to the computer in order to achieve predetermined functions.

(2) One or more or all of the structural elements included in the above-described system may be configured as single system large-scale integration (LSI). The system LSI is ultra-multifunctional LSI manufactured by integrating a plurality of components on a single chip, and specifically a computer system that may include, for example, a microprocessor, ROM, and RAM. The RAM stores computer programs. The system LSI achieves its function as a result of the microprocessor operating in accordance with the computer programs.

(3) One or more or all of the structural elements included in the above-described system may each include an IC card or a stand-alone module that is detachable from the devices. The IC card or the module may be a computer system that may include, for example, a microprocessor, ROM, and RAM. The IC card or the module may include the aforementioned ultra-multifunctional LSI. The IC card or the module achieves its function as a result of the microprocessor operating in accordance with the computer programs. The IC card or the module may be tamper resistant.

(4) The present disclosure may be implemented as the above-described methods. The present disclosure may also be implemented as a computer program that realizes these methods by a computer, or may be implemented as digital signals generated by the computer program.

Moreover, the present disclosure may also be a computer program or digital signals recorded on a computer-readable recording medium, such as a flexible disk, a hard disk, a compact disc (CD)-ROM, a digital versatile disc (DVD), a DVD-ROM, a DVD-RAM, a Blu-ray (BD: registered trademark) disc, or semiconductor memory. The present disclosure may also be implemented as digital signals recorded on such a recording medium.

Moreover, the present disclosure may be implemented by transmitting computer programs or digital signals via, for telecommunication lines, wireless or wired example, communication lines, networks typified by the Internet, or data broadcasting.

Moreover, the present disclosure may also be implemented as another independent computer system by transferring programs or digital signals recorded on a recording medium or by transferring programs or digital signals via, for example, a network.

While various embodiments have been described herein above, it is to be appreciated that various changes in form and detail may be made without departing from the spirit and scope of the present disclosure as presently or hereafter claimed.

### Further Information about Technical Background to this Application

The disclosure of the following patent application including specification, drawings, and claims are incorporated herein by reference in their entirety: Japanese Patent Application No. 2024-013339 filed on Jan. 31, 2024.

### INDUSTRIAL APPLICABILITY

The driving assistance system of the present disclosure has an effect of being able to appropriately determine the risk of driving of a vehicle, and can be applied to, for example, a system and the like that are provided in the vehicle.

1. A driving assistance system comprising:
memory; and
a processor connected to the memory, wherein
the processor:
detects a driving scene of a vehicle according to an output from one or more sensors provided in the vehicle;
detects a cognitive action of a driver who drives the vehicle, according to an output from one or more sensors provided in the vehicle; and
determines a degree of risk of driving of the vehicle by the driver, based on at least the driving scene detected and the cognitive action detected.

2. The driving assistance system according to claim 1, wherein
in determination of the degree of risk, the processor determines the degree of risk by performing scoring of driving of the vehicle by the driver, and
a driving score is smaller when the degree of risk is higher, the driving score being a score obtained by the scoring.

3. The driving assistance system according to claim 2, wherein
in the determination of the degree of risk, the processor further determines whether or not the driving score is less than a risk threshold value, and
the processor further uploads, to a server, driving video data obtained by imaging in the driving scene, when it is determined that the driving score is less than the risk threshold value.

4. The driving assistance system according to claim 3, wherein
the processor further generates, from one or more items of moving image data obtained by imaging with a camera provided in the vehicle, the driving video data by selecting and editing a portion corresponding to the driving scene detected.

5. The driving assistance system according to claim 1, wherein
the processor further detects a movable object in a vicinity of the vehicle, according to an output from one or more sensors provided in the vehicle, and
in determination of the degree of risk, the processor determines the degree of risk based on a detection result of the movable object.

6. The driving assistance system according to claim 1, wherein
the processor further detects visual observation by the driver of one or more objects in vicinity of the vehicle, according to an output from one or more sensors provided in the vehicle, and
in determination of the degree of risk, the processor determines the degree of risk based on a detection result of the visual observation.

7. The driving assistance system according to claim 1, wherein
the processor further detects behavior of the vehicle, and
in determination of the degree of risk, the processor determines the degree of risk based on a detection result of the behavior by the vehicle behavior detector.

8. The driving assistance system according to claim 1, wherein
the processor further detects a predetermined device operation by the driver as a dangerous operation, according to an output from one or more sensors provided in the vehicle, and
in determination of the degree of risk, the processor determines the degree of risk based on a detection result of the dangerous operation by the dangerous operation detector.

9. The driving assistance system according to claim 3, wherein
in determination of the degree of risk, when the processor determines that the driving score is less than the risk threshold value, the processor further:
selects, from a plurality of individual risk threshold values, an individual risk threshold value associated with the driver; and
determines whether or not the driving score is less than the selected individual risk threshold value, and
in uploading of the driving video data, the processor uploads the driving video data to the server when the driving score is less than the risk threshold value and is less than the individual risk threshold value.

10. The driving assistance system according to claim 9, wherein
the processor further determines, based on driving histories of a plurality of persons, each of the plurality of individual risk threshold values corresponding to the plurality of persons.

11. The driving assistance system according to claim 10, wherein
in determination of the plurality of individual risk threshold values, the processor determines, for each of a plurality of combinations, the individual risk threshold value corresponding to the combination,
each of the plurality of combinations is a combination including one of the plurality of persons including the driver, and one of a plurality of driving scenes, and
in selection of the individual risk threshold value, the processor selects, from the plurality of individual risk threshold values, the individual risk threshold value associated with a combination of the driver and the driving scene detected.

12. The driving assistance system according to claim 10, wherein
in determination of the plurality of individual risk threshold values, the processor determines, for each of a plurality of combinations, the individual risk threshold value corresponding to the combination,
each of the plurality of combinations is a combination including one of the plurality of persons including the driver, and one of a plurality of locations, and
in selection of the individual risk threshold value, the processor selects, from the plurality of individual risk threshold values, the individual risk threshold value associated with a combination of the driver and a location where the vehicle is travelling in the driving scene detected.

13. The driving assistance system according to claim 1, wherein
the processor further determines, based on driving histories of a plurality of persons, a prescribed time period corresponding to each of the plurality of persons, and
in determination of the degree of risk, the processor:
selects a prescribed time period associated with the driver from a plurality of prescribed time periods determined, the plurality of prescribed time periods each being the prescribed time period; and
determines the degree of risk by comparing a time period during which the cognitive action detected has been performed with the prescribed time period.

14. A driving assistance method to be performed by computer, the driving assistance method comprising:
detecting a driving scene of a vehicle according to an output from one or more sensors provided in the vehicle;
detecting a cognitive action of a driver who drives the vehicle, according to an output from one or more sensors provided in the vehicle; and
determining a degree of risk of driving of the vehicle by the driver, based on at least the driving scene detected and the cognitive action detected.
